(19) United States
(12) Patent Application Publication
(10) Pub. No.: US 2023/0173488 A1
(43) Pub. Date: Jun. 8, 2023

(54) MIXER FOR GENERATING PARTICLES

(71) Applicant: STEMIRNA THERAPEUTICS CO., LTD, Shanghai (CN)

(72) Inventors: Lei HUANG, Shanghai (CN); Yujian ZHANG, Shanghai (CN); Hang Wen LI, Shanghai (CN); Hai YU, Dailian, Liaoning (CN)

(21) Appl. No.: 17/998,549

(22) PCT Filed: Jan. 12, 2021
(86) PCT No.: PCT/CN2021/071253

§ 371 Date: Nov. 11, 2022

(30) Foreign Application Priority Data
May 15, 2020 (CN) 202010414239.9
May 15, 2020 (CN) 202020811511.2
Dec. 8, 2020 (CN) 202011443666.6

(51) Int. Cl. B01L 3/00

(52) U.S. Cl. CPC B01L 3/502746; B01L 2200/0642; B01L 2300/088; B01L 2400/086

(57) ABSTRACT

A mixer for generating particles, comprising a first mixing unit, wherein the first mixing unit comprises a first channel (702) and a second channel (701), the first channel (702) comprises a rectilinear channel, the second channel (701) comprises a curvilinear channel. The mixer is particularly suitable for producing nanoparticles, and the mixing efficiency can be improved. A microfluidic hybrid chip cartridge prepared by the mixer is also provided.

### CROSS REFERENCES

The present invention claims priority to an invention application No. CN 202010414239.9, entitled “Microfluidic Hybrid Chip Cartridge for Generating Nanoparticles in Parallel with High-throughput” and filed on May 15, 2020; a utility model application No. CN 202020811511.2, entitled “Microfluidic Hybrid Chip Cartridge for Generating Nanoparticles in Parallel with High-throughput” and filed on May 15, 2020 and an Invention application No. CN 202011443666.6, entitled “Mixer for producing particles” filed on Dec. 8, 2020.

### FIELD OF THE INVENTION

The invention relates to the field of microfluid control, in particular to a mixer for generating particles.

### BACKGROUND OF THE INVENTION

Micron materials and nanomaterials are widely used in the fields of chemical industry, electronics, medicine, biology and the like. In general, a conventional chemical stirring synthesis method is usually used for synthesizing microparticles and nanoparticles, and the size and morphology of the particles can be controlled by reducing agents, surfactants, reaction vessel volume, stirring efficiency, reaction time and other factors. Mixing of the reaction liquids is the most important factor for synthesizing nanoparticles. In a conventional synthesis device, a liquid stirring and mixing method is generally used, this method is relatively mature, but its mixing efficiency and mixing uniformity are difficult to control quantitatively or accurately, and cannot meet the requirements of producing high-quality nanoparticles.

The microfluidic technology, as an emerging cross-science technology, has been applied in many fields such as chemistry, chemical engineering, biology, physics and the like, and in the aspects including organic synthesis, inorganic particle synthesis, biomaterials, drug synthesis and the like, featuring that it can accurately control micro-fluids, and has the advantages of being miniaturized, multifunctional, easy to integrate and the like. In the synthesis of micro-nanoparticles, the microfluidic technology has become a development trend of basic research and industrial application at present instead of the conventional synthesis method.

Performance of microfluidic mixers is the core of microfluidic synthesis technology, which determines quality and efficiency of generated nanoparticles. The microfluidic mixers are generally divided into active micromixers and passive micromixers, wherein the active micro-mixer achieves effective mixing by utilizing moving components or external energy, is complex in structure and difficult to integrate; the passive micromixer does not need any external energy, a fluid flow field is changed by changing a geometry of a micro-channel, and then a fluid working medium is efficiently mixed. The microfluidic mixers are easy to manufacture and few in matched facilities and are developed widely.

Ansari et al. proposed a staggered chevron micro-mixer, which is designed to increase the contact area between the two fluids by creating lateral flow; Mengeaud et al. have studied the experimental and numerical simulations of the zigzag micro-channel, a vortex is formed by using the turning region of the micro-channel, and the mixing efficiency is improved; Liu et al. studied stereoscopic serpentine channel micromixers, square wave micromixers and rectilinear channel micromixers; Ansari et al. studied the effect of geometric parameters of a stereoscopic serpentine channel with repeating L-shaped circulation cells on fluid flow and mixing; Mouza et al. further improved a micromixer with an arc-shaped channel by using the principle of separation and recombination, and enhanced mixing by utilizing balanced collision generated by fluid in split sub-channels with uniform width and Dean vortex induced by arc-shaped sub-channels; on this basis, Ansari et al. carried out numerical simulation and experimental research on a micromixer for separating and recombining asymmetric circular channels in plane, and enhanced the mixing by utilizing the unbalanced collision generated by the asymmetrical sub-channels of the micromixer, aiming at the problems in the research of Mouza and the like.

However, when the existing microfluidic hybrid chip is used for preparing nanoparticles, the mixing effect is not high, and even blockage is easy to occur, such that the quality of the prepared nanoparticles is not stable enough.

In addition, under the condition of the prior art, a liquid inlet of a microfluidic hybrid chip cartridge is usually arranged on a lower surface of the chip, the liquid inlet is vertically arranged on the lower surface of the chip, and when the microfluidic hybrid chip cartridge is used, the syringe is used for vertically injecting sample liquid upwards. Then as air bubbles are remained in the syringe due to a blank area of the top of the syringe, although the air bubbles at the top of the syringe can be manually removed in advance to enable the liquid sample to fill the whole syringe, expensive liquid samples will be wasted. Meanwhile, due to the fact that the liquid inlet and the lower surface of the chip form a T-shaped vertical arrangement, a plurality of microfluidic hybrid chip cartridges cannot be superposed, and use of the plurality of microfluidic hybrid chip cartridges in parallel with high-throughput is difficult to realize.

### SUMMARY OF THE INVENTION

In order to solve the problems, the present invention provides a mixer for generating microparticles in parallel with high-throughput and a microfluidic hybrid chip cartridge containing the same. According to an inventive structural design, the mixing efficiency can be greatly improved, a waste of expensive sample liquid can be effectively reduced, and use of a plurality of microfluidic hybrid chip cartridges in parallel with high-throughput can be realized, and high-quality and high-efficiency production of nanoparticles can be realized.

In one aspect, the present invention provides a mixer. The mixer includes a first mixing unit including a first channel and a second channel, the first channel including a rectilinear or substantially rectilinear channel and the second channel including a curvilinear or substantially curvilinear channel.

In some embodiments, the first and second channels constitute a mixing unit.

In some embodiments, the first channel includes a channel inlet and a channel outlet, and the second channel also includes a channel inlet and a channel outlet. In some embodiments, the inlet of the first channel is in communication with the inlet of the second channel to allow a fluid to flow into the first channel at the inlet of the first channel. In some embodiments, the fluid can flow into the second channel at the inlet of the second channel. In some embodiments, the fluid enters the first and second channels at a first convergence of the first and second channels, respectively. In some embodiments, the fluid passing through the first channel and the fluid passing through the second channel mix or converge at the outlets of the first and second channels. In some embodiments, the fluid enters the second converging region to mix or converge at the outlets of the first and second channels.

In some embodiments, the first and second channels are connected head to end separately to form a fluid communication.

In some embodiments, the first and second channels are connected head to end, separately, i.e. the first and second channels are connected head to head and end to end.

Further, the first channel includes a first inlet and a first outlet, the second channel includes a second inlet and a second outlet, the first inlet being in fluid communication with the second inlet; the first outlet being in fluid communication with the second outlet.

Further, the mixing unit further includes a first converging region, the first converging region being in communication with the first inlet of the first channel and the second inlet of the second channel to divert a fluid.

Further, the mixing unit further includes a second converging region, the second converging region being in communication with the first outlet of the first channel and the second outlet of the second channel to converge fluids.

Further, a curvilinear channel of the second channel includes a semi-circular arc-shaped channel.

In the embodiments as above, the second channel includes a rectilinear initial channel, the initial channel being disposed in the upstream side of the curvilinear channel. In some embodiments, the initial channel has an acute included angle with the rectilinear first channel. In some embodiments, a length of the initial segment is less than or equal to ⅓ of a length of the second channel.

Further, an included angle between the initial channel and the first channel is an acute angle of less than 90 degrees.

Further, the mixer further includes a premixing channel, the premixing channel being in communication with the first converging region and mixing two different fluids.

Further, the mixer further includes a first transporting channel for transporting a first fluid and a second transporting channel for transporting a second fluid, the first and second transporting channels being in fluid communication with the premixing channel.

Further, the mixer further includes a second mixing unit including a third channel and a fourth channel, wherein the third channel includes a curvilinear channel and the fourth channel includes a rectilinear channel.

Further, the third channel includes a third inlet and the fourth channel includes a fourth inlet.

Further, the inlet of the fourth channel is adjacent to the outlet of the second channel of the first mixing unit, or the inlet of the fourth channel and the outlet of the second channel of the first mixing unit are on the same side of the channel, or the third inlet of the third channel is disposed opposite to the outlet of the first channel of the first mixing unit.

Further, the fourth channel is disposed at an obtuse angle of greater than 90 degrees with the first channel.

Further, the third channel further includes a rectilinear initial segment in an upstream side of the curvilinear channel, the initial channel being a partial extension of the first rectilinear channel.

Further, a third converging region is provided, the fluid in the third converging region partially entering the third channel and partially entering the second channel.

Further, the mixer further includes a second mixing unit including a third channel and a fourth channel, wherein the third channel includes a curvilinear channel and the fourth channel includes a rectilinear channel, the third channel and the first channel are on the same side of the mixing unit, and the fourth channel and the second channel are on the other same side of the mixing unit.

Further, the mixer further includes a second mixing unit, wherein the first mixing unit is located in the upstream side of the second mixing unit, and the second mixing unit includes a third channel and a fourth channel, wherein the third channel includes a curvilinear channel and the fourth channel includes a rectilinear channel; and with reference to the fourth channel, the curvilinear channel of the first mixing unit and the curvilinear channel of the second mixing unit are separately positioned on either side of the fourth channel.

In all of the preceding embodiments, the channels are equal in width or height, or are same in cross-sections.

In some embodiments, the channel section of the mixer provided by the present invention is rectangular, and lengths and widths of the sections of all channels are kept consistent.

In another aspect, the present invention provides a mixer for generating nanoparticles. The mixer includes n mixing units, wherein each of the mixing units includes a first channel including a rectilinear channel, and a second channel including a curvilinear channel, the first channel being provided with a first inlet and a second outlet, the second channel being provided with a third inlet and a fourth outlet, the first inlet and the third inlet being in fluid communication, wherein n is a natural integer from 1 to 6.

In yet another aspect, the present invention provides a mixer for generating microparticles. The mixer includes a first mixing unit, wherein the first mixing unit includes a first channel for receiving a first fluid and a second channel for receiving a second fluid, wherein a flow path of the first fluid in the first channel is smaller than a flow path of the second fluid in the second channel.

In yet another aspect, the present invention provides a mixer for generating microparticles. The mixer includes a first mixing unit, wherein the first mixing unit includes a first channel for receiving a first fluid and a second channel for receiving a second fluid, and wherein a length of the first channel is smaller than a length of the second channel.

In some embodiments, the first channel is provided with a first fluid inlet and a first fluid outlet, the second channel is provided with a second fluid inlet and a second fluid outlet, wherein the first fluid inlet and the second fluid inlet are in fluid communication.

In some embodiments, a mixing channel is further included in the upstream side connecting the first converging region, the mixing channel connects the first fluid inlet and the second fluid inlet, such that the fluid flows in the first converging region partially into the first channel and partially into the second channel.

In a further aspect, the present invention provides a mixer for nanoparticles, which includes N+1 mixing units, the N^{th} mixing unit including an a^{th} rectilinear channel and an a+1^{th} curvilinear channel, the a^{th} rectilinear channel including an a^{th} fluid inlet and an a^{th} fluid outlet, the a+1^{th} curvilinear channel including an a+1^{th} inflow inlet and an a+1^{th} fluid outlet, wherein N is a natural integer equal to or greater than 1, and a is a natural number greater than or equal to 1.

Further, the fluid inlet of the a^{th} rectilinear channel and the fluid inlet of the a+1^{th} curvilinear channel includes an a^{th} converging region to divert fluids at the converging region; alternatively, the fluid outlet in the a^{th} rectilinear channel and the fluid outlet in the a+1^{th} curvilinear channel includes an a+1^{th} converging region to mix or converge or merge the fluids from the two channels.

Further, the N+1^{th} mixing unit includes an a+2^{th} rectilinear channel and an a+3^{th} curvilinear channel, the a+2^{th} rectilinear channel includes an a+2^{th} fluid inlet and an a+2^{th} fluid outlet, and the a+3^{th} curvilinear channel includes an a+3^{th} fluid inlet and an a+3^{th} fluid outlet.

Further, the a^{th} fluid outlet is disposed opposite to the a+3^{th} fluid inlet.

Further, an a+1^{th} fluid outlet is disposed adjacent to an a+2^{th} fluid inlet or on the same side of a channel.

Further, an upstream side of the curvilinear channel includes a rectilinear channel including a fluid inlet of the curvilinear channel.

Further, the mixer includes a pre-premixing channel for flowing the fluid into the first and second channels, the pre-premixed fluid channel being in the upstream sides of the first and second channels, or a rectilinear channel and an a+1^{th} curvilinear channel, where a=1.

Further, the pre-premixing channel includes a mixed fluid of the first and second fluids.

Further, the first fluid includes a nucleic acid and the second fluid includes a polymer.

Further, the first fluid includes a nucleic acid and the second fluid includes a lipid component.

Further, the first fluid includes microparticles formed by the nucleic acid and the polymer and the second fluid includes a lipid component.

In some embodiments, two channels are included in the upstream side of the mixing channel for guiding two liquids or fluids, and the two channels converge at a convergence where they contact and flow into a mixing channel to form a mixed fluid.

In some embodiments, a first inlet channel and a second inlet channel that converge at an inlet of the mixing channel are included in the upstream side where the mixing channel is connected. In some embodiments, a first inlet channel is used for receiving a first fluid and a second channel is used for receiving a second fluid, the first and second fluids being mixed at an inlet of the mixing channel to form a mixed fluid and flow into the first mixing channel.

In the embodiments stated above, the second channel includes an arc-shaped channel and the first channel includes a rectilinear channel.

In some embodiments, the mixer further includes a second mixing unit which includes a third channel including a curvilinear channel and a fourth channel including a rectilinear channel. In some embodiments, the inlet of the curvilinear channel described in the second mixing unit is in the same or substantially the same rectilinear position as the rectilinear channel of the first mixing unit. In some embodiments, the inlet of the rectilinear channel in the second mixing unit has an acute included angle with the outlet of the rectilinear channel. In some embodiments, the second mixing unit further includes a rectilinear initial channel in an upstream side of the curvilinear channel. In some embodiments, the initial channel is co-linear or substantially co-linear with the rectilinear channel of the first mixing unit. In some embodiments, the rectilinear initial channel has an acute included angle with the fourth channel.

In another example, when the fluid, for example, flows to the second mixing unit, the fluid enters the third and fourth channels, wherein a path through which the fluid flows in the third channel is greater than a path through which the fluid flows in the fourth channel.

In some embodiments, the mixer further includes third and fourth mixing units, wherein the third mixing unit is as same in mechanism as the first mixing unit, the fourth mixing unit is as same as the second mixing unit in structure, and the third and fourth mixing units are distributed in the same manner as the first and second mixing units are.

In some embodiments, the third channel of the second mixing unit includes a third inlet and a third outlet; and the fourth channel includes a fourth inlet and a fourth outlet. In some embodiments, the outlet of the first channel is opposite to the inlet of the third channel. In some embodiments, the inlet of the fourth channel is adjacent to the inlet of the second channel, and the latter is adjacent to each other. In some embodiments, the inlet of the fourth channel is adjacent to the inlet of the second channel on the same side of the channel. In some embodiments, the inlet of the third channel and the inlet of the fourth channel communicate with a third converging region. In some embodiments, the third converging region is located in the downstream side of the second converging region.

In some embodiments, the present invention provides a mixer including N mixing units, wherein N is a natural integer greater than 1; and N may be a natural number such as 1, 2, 3, 4, 5, 6, 7, 8, etc. In some embodiments, N is equal to 2, 3, 4, 5, 6, 7, or may be any other natural integers. In some embodiments, N is a natural even number. In some embodiments, when N is a natural even number, each of the mixing units is connected end to end; wherein two adjacent mixing units are a first mixing unit and a second mixing unit, a second channel of the first mixing unit is positioned on a right side of a first channel, and a second channel of the second mixing unit is positioned on a left side of the first channel. In some embodiments, the first channel of the first mixing unit and the first channel of the second mixing unit are rectilinear channels, and the second channel of the first mixing unit and the second channel of the second mixing unit include curvilinear channels. Alternatively, in some embodiments, a length of the first channel of the first mixing unit is smaller than a length of the second channel.

In some embodiments, the present invention provides a mixer including a first mixing unit formed by two mixing channels, and the two mixing channels form a “D” shape. In some embodiments, the resulting channel includes one fluid incoming end and one fluid outgoing end, and a fluid that needs to be mixed enters one end of the channel to be divided into two fluids, and the divided two fluids converge at one end of the fluid outgoing end after passing through the latter two channels. In some embodiments, the mixer includes a second mixing unit formed by two mixing channels, and the two mixing channels form a “D” shape, wherein the second mixing unit and the first mixing unit are arranged in opposite directions. In some embodiments, the curvilinear channels of the first mixing unit are arranged oppositely to those of the second mixing unit. In some embodiments, the first mixing unit is disposed at an obtuse or acute angle with the second mixing unit.

In some embodiments, the mixer includes N mixing units, where N is a natural integer greater than 1; N can be a natural number such as 1, 2, 3, 4, 5, 6, 7, or 8. In some embodiments, N is equal to 2, 3, 4, 5, 6, 7, or any other natural integers, wherein each of the mixing units are formed by two mixing channels that form a “D” shaped channel mixing unit.

In some embodiments, the mixer includes a channel for discharging particles or microparticles in the downstream side of the mixing unit.

According to the present invention, creative design and improvement for the structure are carried out on the basis of the existing separation and recombination type mixing conduit, such that one channel is guaranteed to be rectilinear, the other path is semi-circular arc-shaped with an innovative structure, the widths of all the channels are consistent, the flow resistance is reduced as much as possible, foreign matter cannot be blocked easily, and the mixing effect is greatly improved.

In yet another aspect, the present invention provides a microfluidic hybrid chip cartridge including a mixer structure as described above and simultaneously provided with a liquid inlet, a liquid outlet, a liquid inlet conduit and a liquid outlet conduit, wherein the liquid inlet includes two ports for respectively transporting in different liquids or fluids.

The liquid inlet and the liquid outlet are perpendicular to a side wall of the chip; the liquid inlet conduit is connected with the liquid inlet and the mixer, the liquid outlet conduit is connected with the liquid outlet and the mixer, and a packaging cartridge is provided outside the chip.

Further, two or more liquid inlets are provided, and the liquid inlet and the liquid outlet are respectively located at two ends of the chip.

Two liquid inlets consisting of a first liquid inlet and a second liquid inlet are provided, a solution from the first liquid inlet is referred to as a first solution, and a solution from the second liquid inlet is referred to as a second solution.

The one connected with the first liquid inlet is a first liquid inlet conduit, the one connected with the second liquid inlet is a second liquid inlet conduit, and the first liquid inlet conduit and the second liquid inlet conduit are connected with a top channel of the mixer together; and the liquid outlet conduit is connected with the bottom channel of the mixer, and the other end of the liquid outlet conduit is connected with the liquid outlet.

Further, the liquid inlet and the liquid inlet conduit are located in the same plane, and the liquid outlet and the liquid outlet conduit are located in the same plane.

Furthermore, the liquid inlet, the liquid inlet conduit, the liquid outlet, the liquid outlet conduit and the chip are all substantially located in the same plane.

Of course, the fact that the inlet, the inlet conduit, the outlet, the outlet conduit and the chip are located substantially in the same plane to merely reduce the volume and facilitate manufacturing, in some embodiments, may be located in different planes, respectively, or any two or more of them may be located in the same plane, all of which are within the protection scope of the present invention.

Compared with the prior art, the microfluidic hybrid chip cartridge provided by the present invention has the advantages that the liquid inlet and the liquid outlet are arranged perpendicular to a side wall of a chip. When it is used, a syringe is disposed vertically downward for injection, the chip and the syringe are in the same plane, and the syringe is placed vertically downward after it extracts a liquid sample, such that bubbles naturally float to the top inside the syringe, then the syringe is inserted vertically downward into a liquid inlet of the chip, and the liquid in the syringe is completely injected into the liquid inlet. The bubbles float to the top of the syringe, thus are not injected in, and a waste of expensive sample liquid due to manual removal of bubbles at the top of a syringe is avoided.

In yet another aspect, the present invention also provides a microfluidic hybrid chip cartridge for generating a microparticle in parallel with high-throughput, and the cartridge is formed by stacking a plurality of microfluidic hybrid chip cartridges as described above in parallel.

Due to the fact that the liquid inlets, the liquid outlet and the chip are in the same plane, injection only needs to be carried out from a side surface of the chip during sample application, a plurality of microfluidic hybrid chips can be stacked, thus the microfluidic hybrid chips can be used in parallel with high-throughput, and a microfluidic hybrid chip cartridge for generating microparticles in parallel with high-throughput is prepared.

In yet another aspect, the present invention provides a method for preparing microparticles, including: providing the mixer as described above to pass a fluid from a premixing channel into a first mixing unit, wherein a part of the fluid enters a first channel of the first mixing unit and the other part of the fluid enters a second channel of the first mixing unit.

In some embodiments, the two channels are provided with a substantially co-located converging inlet and a substantially co-located converging outlet. In some embodiments, an inlet into the first channel and an inlet into the second channel are included as inlets. In some embodiments, an outlet from the first channel and an outlet from the second channel are included as outlets.

Further, a premixed fluid flows in through a first inlet of a first channel in communication with a first converging region and then flows through a second inlet of a second channel.

Further, fluids passing through the first and second channels of the first mixing unit converge at a second converging region.

Further, a fluid from the first converging region enters the third and fourth channels, respectively, through inlets of the third and fourth channels of the second mixing unit in communication with the third converging region.

Further, to make the fluid flow in the first mixing unit is achieved by applying a pressure to channel externally.

Further, the first and second fluids are first premixed in the premixing channel.

In yet another aspect, the present invention provides a method for preparing microparticles, including: providing the mixed fluid, wherein a part of the fluid passes through a first channel, and a remaining part of the fluid passes through a second channel, and wherein the path through which the fluid passes in the first channel is smaller than the path through which the fluid passes in the second channel.

Further, the fluid includes one or more of a nucleic acid, a polymer, or a lipid component substance.

Further, the first channel includes a rectilinear channel and the second channel includes a curvilinear channel.

Further, a premixing channel is provided in the upstream side of the first and second channels, a first fluid and a second fluid being mixed into a mixed fluid in the premixing channel.

In some embodiments, the fluid enters the first and second channels, respectively, through an inlet at a convergence, and then exits through an outlet at the convergence. In some embodiments, the path through which the fluid flows in the first channel is smaller than the path through which the fluid flows in the second channel.

In some embodiments, the fluid flows in a rectilinear path in the first channel and the fluid flows in a curvilinear path in the second channel.

In some embodiments, the mixer includes a second mixing unit provided with a channel disposed as same as that of the first mixing unit, but disposed at an angle to the first mixing unit. In some embodiments, the mixer may include a structure of repeatedly arranged first and second mixing units, wherein the repeatedness may be repeated for three or more times.

In some embodiments, before a fluid enters a mixing unit, a premixing channel is included in the upstream side of the mixing unit, and the two fluids are mixed in the premixing channel. In some embodiments, two channels are included in the upstream side of the mixing channel, each receiving a different fluid, and the two different fluids flow into the mixing channel for mixing to form a mixed fluid. In some embodiments, the mixed fluid flows into a converging inlet of the mixing unit so as to enter the first and second channels, flows out through the converging outlet, and enters the next mixing unit.

In some embodiments, one of the two different fluids includes a nucleic acid substance, the other fluid includes a polymer, a polypeptide, or the other fluid includes a lipid component. Alternatively, one of the two different fluids includes polymer particles formed in combination with the nucleic acid substance, or the other fluid comprises a lipid component.

The mixer and the microfluidic hybrid chip cartridge for generating microparticles in parallel with high-throughput provided by the present invention have the following beneficial effects:

1. Arrangement of the conduits of the mixer is innovated, such that each of the mixing units simultaneously includes a rectilinear mixing path and an arc-shaped mixing path, the widths of all conduits are consistent, the flow resistance is reduced as much as possible, and the mixing effect can be improved.

2. The created mixing conduit formed by six semicircular mixing units can improve the mixing efficiency, has smaller flow resistance, is not easy to block foreign matters, has more stable performance, and is particularly suitable for producing nanoparticles.

3. The liquid inlet and the liquid outlet are perpendicular to a side wall of the chip, such that bubbles can be prevented from entering during injection, and meanwhile waste of an expensive sample liquid due to manual removal of bubbles at the head of a syringe is avoided.

4. Due to the fact that the liquid inlets, the liquid outlet and the chip are in the same plane, injection only needs to be carried out from a side surface of the chip during sample application, a plurality of microfluidic hybrid chips can be stacked, thus the microfluidic hybrid chips can be used in parallel with high-throughput and can be used for generating a microparticle in parallel with high-throughput.

5. It is convenient, efficient and easy to popularize.

### DETAILED DESCRIPTION

The present invention provides a microfluidic hybrid chip cartridge and a mixer thereof, which are configured to prepare a nanoparticle for scientific research or therapeutic applications. The system can be used to generate a wide variety of nanoparticles, including but not limited to polymers and lipid nanoparticles carrying a variety of loads. The system provides a simple workflow that can be used to produce sterile products in some embodiments.

### Microfluidic Hybrid Chip Cartridge

A microfluidic hybrid chip cartridge is a hot spot for development of a micro-total analysis system, which provides a convenient platform for combining two or more microfluidic streams within a microfluidic mixer.

The microfluid hybrid chip cartridge, which takes the chip as an operating platform, analytical chemistry as a basis, a micro electro mechanical processing technology as a support and a micro pipeline network as a structural characteristic, takes life science as a major application object. The device is mainly featured by an effective structure (a channel, a reaction chamber and some other functional components) for containing the fluid is in a micron scale at least in one latitude, and due to the micron scale structure, the fluid shows and forms special properties different from the macroscopic scale therein, and the device has the characteristics of controllable liquid flow, little consumption of samples and reagents and the like.

In some embodiments, the present invention discloses a device for preparing nanoparticles that enables simple, rapid, and reproducible laboratory-scale preparation of nanoions (0.5-20 mL). An application of the device using microfluidic hybrid chip cartridges primarily relates to basic research, particle characterization, substance screening, in vitro and in vivo research, and the like. A microfluidic hybrid chip cartridge disclosed by the present invention has the advantage of precise control of environmental factors during preparation, and microfluidic design has the further advantage of allowing seamless amplification via parallelization. The disclosed Embodiments are configured to mix a first solution and a second solution through a microfluidic mixer. Many methods are known to be used in this mixing process. Compatible microfluidic mixing methods and devices are disclosed in: (1) U.S. patent application Ser. No. 13/464,690, which is a continuation of PCT/CA 2010/001766 filed on Nov. 4, 2010, which claims the benefit of U.S. Ser. No. 61/280,510 filed on Nov. 4, 2009; (2) U.S. patent application Ser. No. 14/353,460, which is a continuation of PCT/CA 2012/000991, filed on Oct. 25, 2012, which claims the benefit of U.S. Ser. No. 61/551,366, filed on Oct. 25, 2011; (3) PCT/US 2014/029116 filed on Mar. 14, 2014 (published as WO 2014172045 on Oct. 23, 2014), which claims the benefit of U.S. Ser. No. 61/798,495 filed on Mar. 15, 2013; (4) PCT/US 2014/041865 (published as WO 2015013596 published on Jan. 29, 2015) filed on Jul. 25, 2014, which claims the benefit of U.S. Ser. No. 61/858,973 filed on Jul. 26, 2013; (5) PCT/US 2014/060961 which claims the benefit of U.S. Ser. No. 61/891,758 filed on Oct. 16, 2013; and (6) U.S. Provisional Patent Application No. 62/120,179, filed on Feb. 24, 2015, which is incorporated herein by reference in its entirety.

According to the currently prepared microfluidic hybrid chip cartridge combining an accessory and a microfluid control, it is unnecessary for a user to assembly the cartridge, and the microfluidic hybrid chip cartridge is operated under higher pressure and minimizes an internal volume, and a pre-sterilized microfluidic hybrid chip cartridge with a sterile fluid path can also be provided. There are disposable and non-disposable microfluidic hybrid chip cartridges, the nature of the disposable cartridges may reduce the risk of cross-contamination and shorten experimental time by eliminating washing.

In some embodiments, a microfluidic hybrid chip cartridge is disposable. The term “disposable” as used herein refers to a component that is relatively low cost relative to a product (e.g., a nanodrug) produced by a microfluidic hybrid chip cartridge. In addition, a disposable microfluidic hybrid chip cartridge has a limited service life, such as being suitable for single use only, as described below. Disposable materials broadly include plastics, magnets (e.g., inorganic materials), and metals.

In some embodiments, the microfluidic hybrid chip cartridge is configured for a single use. In this regard, the configuration of the microfluidic hybrid chip cartridge entails low preparation costs and thus allows a user to deal with the cartridge after use. In certain embodiments, characteristics of the cartridge change after a single use, which thus makes the cartridge not suitable or cannot be for further use. For example, a sterile cartridge is no longer sterile and thus cannot be reused as a sterile cartridge after a single use. In addition, the cartridge of single use is free of the risk of cross-contamination in mixing. In this regard, the microfluidic hybrid chip cartridge of single use contains a completely unused (uncontacted fluid) fluid path from the inlet connector to the outlet.

The solution mixed in the microfluidic hybrid chip cartridge has a source including a syringe and a pump. By configuring an inlet connector to match the connector connected to the solution source, the microfluidic hybrid chip cartridge can be compatible with any solution source.

The microfluidic hybrid chip cartridge includes a microfluidic hybrid chip therein and a packaging cartridge outside the chip, wherein a microfluidic structure is arranged inside the chip, and the key component of the microfluidic hybrid chip cartridge is a mixer.

The microfluidic hybrid chip cartridge is provided with a chip with an innovative structure design, a mixer with an innovative structure design is arranged in the chip on which a liquid inlet, a liquid outlet, a liquid inlet conduit, a liquid outlet conduit and a mixer are arranged, and the liquid inlet and the liquid outlet are perpendicular to a side wall of the chip; the liquid inlet conduit is connected with the liquid inlet and the mixer, the liquid outlet conduit is connected with the liquid outlet and the mixer, and a packaging cartridge is arranged outside the chip.

Further, two or more liquid inlets are provided, and the liquid inlet and the liquid outlet are respectively located at two ends of the chip.

When there are two liquid inlets, the two liquid inlets are a first liquid inlet and a second liquid inlet respectively, the solution from the first liquid inlet is referred to as a first solution, and the solution from the second liquid inlet is referred to as a second solution.

The one connected with the first liquid inlet is a first liquid inlet conduit, the one connected with the second liquid inlet is a second liquid inlet conduit, and the first liquid inlet conduit and the second liquid inlet conduit are connected with a top channel of the mixer together; and the liquid outlet conduit is connected with the bottom channel of the mixer, and the other end of the liquid outlet conduit is connected with the liquid outlet.

Further, the liquid inlet and the liquid inlet conduit are located in the same plane, and the liquid outlet and the liquid outlet conduit are located in the same plane.

Furthermore, the liquid inlet, the liquid inlet conduit, the liquid outlet, the liquid outlet conduit and the chip are all substantially located in the same plane.

Of course, the fact that the inlet, the inlet conduit, the outlet, the outlet conduit and the chip are located substantially in the same plane to merely reduce the volume and facilitate manufacturing and use, in some embodiments, may be located in different planes, respectively, or any two or more of them may be located in the same plane, all of which are within the protection scope of the present invention.

Compared with the prior art, the microfluidic hybrid chip cartridge provided by the present invention has the advantages that the liquid inlet and the liquid outlet are arranged perpendicular to a side wall of a chip. When it is used, a syringe is disposed vertically downward for injection, the chip and the syringe are in the same plane, and the syringe is placed vertically downward after it extracts a liquid sample, such that bubbles naturally float to the top inside the syringe, then the syringe is inserted vertically downward into a liquid inlet of the chip, and the liquid in the syringe is completely injected into the liquid inlet. As the bubbles float up to the top of the syringe, thus it is not needed to worry about injection of the bubbles, and waste of expensive sample liquid due to manual removal of bubbles at the top of a syringe is avoided.

### Microfluidic Hybrid Chip

In some embodiments, the microfluidic hybrid chip includes a first portion and a second portion, the first portion or the second portion includes a first liquid inlet, a second liquid inlet, and a liquid outlet, or the first portion and the second portion are joined together to form a first liquid inlet, a second liquid inlet, and a liquid outlet, wherein the first portion and the second portion are joined together to enclose the mixer between the first portion and the second portion. For example, as shown in FIGS. 1 and 2, the hybrid chip structure includes a first portion 30 and a second portion 20, and a mixer 22 containing microfluidic channels, the mixer 22 is sealed together by the first portion and the second portion, or the mixer structure is disposed within a cartridge, and the cartridge is sealed together by the first portion and the second portion. The mixer includes mixing units which are all communicated by microfluidic channels, e.g., microfluidic channels on the base plate 102 of the mixer, whereas the cover plate 101 of the mixer covers the base plate 102 to form sealed microfluidic channels. In some embodiments, the mixer unit includes a plurality of mixing units, which generally include two channels for simultaneously flowing the fluids, the fluids flow separately, converge, then flow separately to obtain a microparticle finally with satisfaction. This will be explained in more detail later. To flow a fluid in a channel, there is generally an inlet into the channel, for example as shown in FIGS. 1 and 2, a first inlet 12 and a second inlet 312 are included in the mixer, through which different fluids enter the channel; the two fluids are mixed in the mixer to obtain a microparticle which is then discharged out of the mixer through an outlet 313. Therefore, the lower plate 20 and the upper plate 30 are also provided with a structure of holes which communicate with the liquid inlet and the liquid outlet, respectively, into which the fluid flows. For sealing requirements, sealing gaskets 203, 201, and 202 may be provided among the channel and the inlet and outlet, respectively, to ensure sealing performance requirements. This allows the upper and lower plates to be combined to form a chip cartridge 100.

In some embodiments herein, the first portion of the chip may be referred to as a connection portion and the second portion may be referred to as a top plate. In some embodiments, additional components such as screws and plates are required to couple between the first and second portions of the chip. In one Example, the second portion functions to apply a clamping force to the assembly. In one Example, the second portion contains a layer or structure to evenly distribute the clamping force on the mixer.

In some embodiments, the first and second portions of the chip are secured together by one or more fasteners. In some embodiments, one or more fasteners are removable. Exemplary removable fasteners are screws, nuts and bolts, clips, straps and pins. In still other embodiments, one or more fasteners may be non-removable. In such Embodiments, a fastener may be a nail or rivet. In additional Embodiments, the fasteners may be incorporated into a structure that is a chip. In such Embodiments, one portion may contain pins or tabs, while the second portion has recesses, cutouts, or other structures for receiving the fasteners described above.

In still other embodiments, the first portion and the second portion are joined together. In this Example, the two components are inseparable once coupled. In one Example, the first portion and the second portion are joined together with an adhesive. In one Example, the first portion and the second portion are joined together by welding. Representative suitable welding methods include laser welding, ultrasonic welding, and solvent welding.

In still other embodiments, the chip further includes a gasket configured to form a separate liquid-tight seal among the mixer and the first inlet, the second inlet, and the outlet port. In yet some embodiments, a flange or other features integrated into the chip may be used to form a desired seal. A microfluidic structure is provided inside the chip and includes a mixer for mixing two or more fluids.

### Microfluidic Structure

A microfluidic structure refers to a system or device for manipulating (e.g., flowing, mixing, etc.) a fluid sample including at least one channel on a micron scale (i.e., less than 1 mm in size). The microfluidic structure disclosed by the present invention includes a mixer, a liquid inlet conduit, a liquid outlet conduit and the like in a microfluidic hybrid chip, for example, in FIG. 2, a microfluidic channel located on a substrate includes two channels, namely liquid inlet channels 14 and 314, wherein the two channels are respectively provided with a liquid inlet 12 and a liquid inlet 312 through which a first fluid and a second fluid to be mixed flow into the mixing unit through the channels 14 and 314 for mixing. The first fluid enters the first channel 14, passes through a first preparation channel 103, then enters a converging region 105; the second fluid enters the second channel 314, passes through the second preparation channel 104, and then enters the converging region 105. The first fluid and the second fluid first converge in a converging region 105 and then enter a converging channel 106 together and then enter a mixing unit in the mixer. The fluid obtained after being mixed by the mixer flows out through an outlet channel 303.

### Mixing Unit in a Mixer

A mixer is a “microfluidic element” in a microfluidic hybrid chip cartridge and is one of the key components of a microfluidic structure configured to exceed those of simply flowing solutions in an aspect of function, such as mixing, heating, filtering, reacting, etc. A microfluidic element described in the present invention is a microfluidic mixer configured for mixing a first solution and a second solution in a chip structure to provide a mixed solution to form microparticle components. The mixed solution described herein is not a pure mixed fluid or solution and generally includes or is dissolved in a solution in which substances such as nucleic acids, proteins, polypeptides, polymers, lipid components, etc. are suspended. Generally, solutions of two different components are mixed, for example, one solution includes a nucleic acid substance and the other solution includes a polymer, and when the two solutions are mixed, the nucleic acid substance and the polymer form a microparticle substance, which is then mixed a plurality of times and then filtered or centrifuged to separate out the particulates. Such particle substance may be suspended in the solution and then mixed again with a solution containing the lipid component to coat a particle substance with a layer of the lipid component to form a substance of particles. This is explained in more detail below.

In some embodiments, the present invention provides a mixer including a mixing unit including a first channel which is rectilinear and a second channel which is curvilinear. For example, as shown in FIG. 4, the mixer includes two channels: a first channel 702 and a second channel 701, wherein a length of the first channel is smaller than a length of the second channel. The fluid thus enters the first and second channels, a path through which the fluid flows in the first channel is smaller than a path through which the fluid flows in the second channel. In some embodiments, it will be appreciated that the fluid flows in the first channel for a time shorter than that in the second channel, if at the same pressure. In some embodiments, the two channels each have a liquid inlet and a liquid outlet, e.g., the first channel 702 includes a liquid inlet 107, and a liquid outlet 113, and the second channel 702 includes a liquid inlet 108 and a liquid outlet 112. In some embodiments, the inlet 107 of the first channel and the inlet 108 of the second channel have a first converging region 900 where a fluid flows in the first and second channels respectively. In some embodiments, the first channel includes a liquid outlet 113 and the second channel includes a liquid outlet 112, where two liquid outlets also include a converging region 901, for example a second converging region 901, in which the fluids from the first and second channels respectively are mixed or converged.

Of course, the fluids converged and remixed in the converging region 901 may both enter the next mixing unit. Of course, a fluid from the second converging region may flow into a third converging region 902 such that in the third converging region, the mixed fluid reenters the second mixing unit to flow or flow in the third and fourth channels, respectively, of the second mixing unit. A “converging region” is here to be understood as a place or region where the inlets and outlets of the channels are connected, where the fluids are diverted or converged or remixed. For example, a converging region might have been at an inlet of two channels or at an outlet of two channels, where the fluids are diverted and/or converged. For example, in the first converging region 900, the diverted fluids flow into the first and second channels of the first mixing unit, respectively, and then are converged in the second converging region 901. For the same reason, there are also a third channel and a fourth channel in the second mixing unit, an inlet with a third channel and an inlet with a fourth channel, and an outlet with a third channel and an outlet with a fourth channel, and there is also a third converging region 902 in which the mixed liquid is diverted, in the inlet of the third channel and the inlet of the fourth channel. Similarly, there is a fourth converging region 903 at the outlet of the third channel and the outlet of the fourth channel, where the fluids from the two channels are mixed, converged or merged. Similarly, in this way, there are in succession a plurality of mixing units, a plurality of converging regions to achieve a first diversion of liquid, a first converge of liquid, a second diversion of liquid, a second converge of liquid, a third diversion of liquid and a fourth converge of liquid . . . a N^{th} converge of liquid and a N^{th} diversion of liquid, wherein N is a natural integer, e.g. an integer in front of 1 to 100, e.g. 1, 2, 3, 4, 5, 6, 7, 8, 9, 10, 11, 12, 13, 14, 15, 16, 20, 25, 30, 35, 50, 80, 90, 40, etc. Thus, there are N×2 converging regions, e.g. if N is 1, there are two converging regions, if N=4, there are 8 converging regions, if N=3, there are 6 converging regions, if N=6, there are 12 converging regions. In some embodiments, there are two channels between each two converging regions, wherein one of the channels is rectilinear and the other of the channels is curvilinear, or one of the channels has a length less than that of the other of the channels, or the fluid flow path in one of the channels is less than that in the other of the channels. As shown in FIG. 3, when there are six mixing units, in the converging regions 900, 902, 904, 906, 908, and 910, liquid is diverted or the mixed liquid is diverted, and in the converging regions 901, 903, 905, 907, 909, and 911, the liquid is merged, converged, or mixed.

In some embodiments, the first channel 702 is a rectilinear channel and the second channel 701 is a curvilinear channel, but the two channels are in a converging region at the same location. As used herein, the term “a converging region at the same location” means that the inlets and outlets of the two channels are in substantially the same position without being separated by a significant distance, and it will also be understood that the inlets of the two channels are in the same position, allowing liquid from the converging region to enter both the first channel 702 and the second channel 701 at substantially the same time. For example, the liquid inlet 107 of the first channel and the liquid inlet 108 of the second channel are both in fluid communication with the converging region where the liquid from the converging region 900 flows into the first and second channels, respectively. Flow into the first and second channels, respectively, occurs almost simultaneously. In this way, the fluid can exhibit different flow characteristics in different channels, such as different flow paths of the fluid, different flow resistances, different flow rates, ease of fluidity, etc. For example, the flow path in the first channel may be shorter than that in the second channel, or the flow resistance of the fluid flowing in the first channel may be less than the flow resistance of the fluid flowing in the second channel. Therefore, in order to achieve the flow characteristics of the fluids of the different channels, the first channel 702 can be a rectilinear channel and the second channel includes a curvilinear channel 111, such that the fluids have different flow characteristics in the two channels. In some embodiments, a rectilinear initial segment 110 in communication with or having a liquid inlet 108 is included in the upstream sides of the curvilinear channel 111 in the second channel. As such, one portion of the fluid or mixed fluid from the converging region 900 flows in the rectilinear channel 702 and the other portion enters the curvilinear channel 701 to flow, but the rectilinear initial segment is connected to the curvilinear channel. The fluids from the converging region enter the respective channels at substantially the same flow rate, but the characteristics of the flow rate is substantially differed most by a portion of the curvilinear channel. Clogging and jamming of the fluid at a converging region, and the design is particularly effective for particularly viscous fluids. As shown in FIG. 4, arrows 109 and 123 illustrate a flow pattern of the fluid in the rectilinear channel 702, and arrows 110 and 111 illustrate a flow pattern of the fluid in the second channel 701. At an outlet of the two channels 701 and 702, a converging region 901 where the liquid from the two channels is converged and mixed. Then the liquid flows to the next mixing unit.

In some embodiments, the mixer further includes a second mixing unit connected to the first mixing unit, wherein the second mixing unit has a same physical structure as that of the first mixing unit, but is connected in a manner or has a connection angle different from that of the first mixing unit. The second mixing unit includes a third channel 117 and a fourth channel 116, wherein the third channel includes a curvilinear channel and the fourth channel includes a rectilinear channel. Similarly, the third channel has a third fluid inlet 115 and a third fluid outlet 118, the fourth channel also has a fourth fluid inlet 114 and a fourth fluid outlet 119, the inlets of the two channels are connected to a converging region 902 and the outlets of the two channels are connected to a converging region 903. In some embodiments, for ease of illustration, the converging region 902 may be referred to as a third converging region, the converging region 903 may be referred to as a fourth converging region, a converging region 900 may be referred to as a first converging region, and a converging region 901 may be referred to as a second converging region. In some embodiments, an initial channel 117 of the second mixing unit is located on a same line with the rectilinear channel 702 of the first mixing unit, it is understood that the initial channel 117 in the third channel 118 of the second mixing unit is an extended segment in a rectilinear direction of the rectilinear channel 702. In some embodiments, the inlet 114 of the rectilinear channel of the second unit is on a same side of the channel as the outlet 112 of the curvilinear channel of the first channel. Alternatively, in some embodiments, the inlet 114 of the rectilinear channel of the second unit is positioned or arranged adjacent to the outlet 112 of the curvilinear channel of the first channel. In some embodiments, the inlet 115 of the curvilinear channel of the second mixing unit and the outlet 113 of the rectilinear channel of the first mixing unit are located on the same line, or disposed opposite.

In some embodiments, a rectilinear channel of each of the mixing units is disposed by an acute angle to an initial channel of the other curvilinear channel, wherein the degree of such angle is less than 90°, such as 85°, 70°, 75°, 60°, 65°, 50°, 55°, 45°, 40°, 30°, 35°, 20°, 25°, or 10°.

FIG. 4 is a schematic diagram showing the positional relationship structure of two identical mixing units. FIG. 3 is a schematic diagram showing an arrangement structure of six mixing units of the same structure. As can be seen from FIGS. 4 and 3, the arrangement is regular, and according to the combination of the first mixing unit and the second mixing unit described in FIG. 4, a third mixing unit is provided below the second mixing unit, the third mixing unit being connected to the second mixing unit in the same or substantially the same manner in which the second mixing unit is connected to the first mixing unit. Specifically, as shown in FIG. 3, the third mixing unit is located in the downstream of the second mixing unit, and the second mixing unit is located in the downstream of the first mixing unit. The third mixing unit includes a rectilinear channel 210 and a curvilinear channel 211, meanwhile, the curvilinear channel is connected upstream to a section of a rectilinear channel 212. Similarly, the rectilinear channel can be seen as an extended channel of the rectilinear channel 116 of the second mixing unit, and the third mixing unit also includes a converging region 904 where fluids from the second mixing unit are diverted, and a converging region 905 where fluids from the third mixing unit are converged and mixed. From this point of view, if the rectilinear channel 116 of the second mixing unit is taken as a reference, a curvilinear channel 701 of the first mixing unit is located to the right side of the rectilinear channel and the curvilinear channel 118 of the second mixing unit is located to the left side of the rectilinear channel 116. Alternatively, the rectilinear path 702 of the first mixing unit and the rectilinear path of the third mixing unit are relatively parallel and form an angle with the rectilinear path 116 of the second mixing unit, the degrees of the angle can be greater than 90°, such as 95°, 98°, 100°, 105°, 110°, 115°. 120°, 125°, 130°, 135°, 140°, 145°, 160°, 170°, etc.

The two different fluids are continuously diverted, mixed, diverted, mixed and diverted in the mixing unit, such that the nanoparticle is prepared. This is similar to microfluidic droplet preparation techniques in that the two fluids converge at a convergence to form water-in-oil or oil-in-water droplets by shear forces of the liquid. Nanoparticle or particle is prepared according to the present invention, which may also be liposome-encapsulated nucleic acid, or liposome-encapsulated core structures, which are analogous structures formed by nucleic acids and polymers. Such a substance may be a material of the core structure and a material of the shell structure as described in Chinese Patent Application No. 20188001680.5. All Embodiments in this application are intended to be part of particular embodiments of the present invention.

This regular connection, as can be seen from FIG. 3, includes an arrangement of the curvilinear channels of the first mixing unit opposite the curvilinear channels of the second mixing unit and the connection between the mixing units are free. FIG. 3 is merely one preferred implementation achieving a preparation of a nanoparticle.

Here, it means that all repeated mixing unit structures are identical, but the way they are connected is set regularly, but other ways of connection are not limited.

A structural arrangement of the mixing unit includes: the mixing unit includes two channels, wherein one channel is rectilinear, the other channel is curvilinear, the arc of the curved line is included, and the relative relationship between the curved line and the rectilinear channel is included, such that the external shape of the integrally formed unit further includes a change of the size and the shape of the area at the inlet converging region and the outlet converging region of the two channels, a change in one of these factors, such as the depth and width of the channel, or the size of the cross-sectional area of the channel, may be considered a different mixing element. If there is a plurality of mixing regions, it is preferred that the structure of each mixing region is the same, only the permutation and combination are different, but it is also possible that the structure of each mixing region is different. For example, referring to FIG. 4, there are two mixing units having the same structure but different manners of connection or combination. Of course, it is also possible that mixing units of different structures are connected in the same manner. For example, the structure of the first mixing unit is the same as that illustrated in FIG. 4, but the structure of the second mixing unit may be different from that of the first mixing unit, one or more of the characteristics such as length, width, depth, cross-sectional area, size of the inlet, size of the outlet, curvature of the curved portion of the curvilinear channel, or degree of curvature, a length of the initial rectilinear channel is different from that of the first mixing unit.

In some embodiments, the first and second channels of the first mixing unit are each connected head to end, respectively, which means that the first and second channels are connected head to head and end to end, respectively. Such connections are not communications, but are connections of different converging regions to achieve liquid diversions at the head, merging or convergence of liquids at the tail.

Accordingly, the present invention provides a mixer including N mixing units, wherein each of the mixing units includes a rectilinear channel and a curvilinear channel, each of the mixing units includes a rectilinear fluid inlet and a rectilinear fluid outlet, a fluid inlet and a fluid outlet of the curvilinear channel, wherein N is a natural integer equal to or greater than 1. In some embodiments, the fluid inlet of the rectilinear channel and a stereoscopic inlet of the curvilinear channel communicate with the converging region to divert fluids at the converging region, and the fluid outlet of the rectilinear channel and a stereoscopic outlet of the curvilinear channel communicate with the converging region to mix or converge or merge the fluids from the two channels.

Therefore, the present invention provides a mixer including N+1 mixing units, the N^{th} mixing unit includes an a^{th} rectilinear channel and an a+1^{th} curvilinear channel, the a^{th} rectilinear channel includes an a^{th} fluid inlet and an a^{th} fluid outlet, the a+1^{th} curvilinear channel includes an a+1^{th} inflow inlet and an a+1^{th} fluid outlet, wherein N is a natural integer equal to or greater than 1, and a is a natural number greater than or equal to 1. Alternatively, the present invention provides a mixer including N+1 mixing units, the N^{th} mixing unit includes an a^{th} rectilinear channel and an a+1^{th} curvilinear channel, the a^{th} rectilinear channel includes an a^{th} fluid inlet and an a^{th} fluid outlet, the a+1^{th} curvilinear channel includes an a+1^{th} inflow inlet and an a+1^{th} fluid outlet, wherein N is a natural integer equal to or greater than 1, and a is a natural number greater than or equal to 1. In some embodiments, the length of the a^{th} rectilinear channel is less than the a+1^{th} curvilinear channel; alternatively, a path through which the fluid flows in the a^{th} linear channel is smaller than a path through which the fluid flows in the a+1^{th} curvilinear channel.

In some embodiments, a fluid inlet of the a^{th} rectilinear channel and a stereoscopic inlet of the curvilinear channel include the a^{th} converging region to divert fluids at the converging region, and the fluid outlet of the rectilinear channel and the stereoscopic outlet of the curvilinear channel include the a+1^{th} converging region to mix or converge or merge the fluids from the two channels.

In some embodiments, the N+1^{th} mixing unit also includes an a+2^{th} rectilinear channel including an a+2th fluid inlet and an a+2^{th} fluid outlet, and an a+3^{th} curvilinear channel including an a+3^{th} fluid inlet and an a+3^{th} fluid outlet. In some embodiments, the fluid inlet of the a+2^{th} rectilinear channel and the fluid inlet of the a+3^{th} curvilinear channel includes an a+2^{th} converging region to divert fluids at the converging region; a fluid outlet in the a+2^{th} rectilinear channel and a fluid outlet in the a+3^{th} curvilinear channel includes an a+3^{th} converging region to mix or converge or merge the fluids from the two channels.

In some embodiments, the a^{th} fluid outlet is disposed opposite to the a+3^{th} fluid inlet. In some embodiments, the a+1^{th} fluid outlet is disposed adjacent to an a+2^{th} fluid inlet, or on a same side of a channel.

The mixer composed of a plurality of mixing units in communication with each other provided by the present invention can be referred to as a separating and recombination mixer. The separating and recombination mixer refers to more than two channels (such as a first channel and a second channel) of each mixing unit, wherein each of the mixing units is divided into more than two channels which are connected in parallel and then recombined into one channel. By recombining a channel, it is possible to achieve at least a short converge in the converging region, which means that a length of the merged channels is relatively short, essentially in the same concept as in the converging region, and fluid diversion and converge in the converging region can take place almost simultaneously or at intervals. For example, as shown in FIG. 4, the converging region 901 is a region where two outlet fluids of the first mixing units are mixed or converged, the other converging region 902 is a region where a mixed fluid is rediverted into the channels of the second mixing unit. There is no strict demarcation between the converging region 901 and the converging region 902, illustrated by way of example only for ease of description, although the two converging regions may also be collectively referred to as a converging region to mix and divert fluids that may or may not occur simultaneously.

Further, the curvilinear channel is formed by combining semi-circular arcs or arcs with different circle centers. Of course, the rectilinear path shown herein is merely rectilinear in the general sense and does not require the rectilinear path seen by precision equipment instruments, as compared with a curvilinear path. A curve is a concept as compared with a straight line.

In some embodiments, as shown in FIG. 4 or 3, the two channels forming the mixing unit form a “D” shape or “B” shape, and this mixing unit can be formed by two “D” letters, and the letter “B” includes two mixing units. The mixing unit can be combinations in any other form.

Through a large number of experiments, the research group has found that when the separating recombination mixing conduit is used for forming the nanoparticle, the mixing efficiency is obviously higher than that of mixing conduits of other shapes, and the liquid in the conduit is subjected to mixing, diverting, remixing and rediverting a plurality of times, such that the mixing effect is higher; however, due to the fact that the existing separating and recombination mixing conduits are mostly circular arc rings or fan-shaped and the like, the structure is complex, when used for generating a microparticle, the conduits have a high flow resistance, ease in blockage, and still unsatisfactory mixing effect. According to the present invention, the structure creative design and improvement are carried out on the basis of the existing separating and recombination mixing conduits, such that one path is guaranteed to be rectilinear, the flow resistance is reduced as much as possible, and the other path is semi-circular arc-shaped, such that the mixing effect is greatly improved.

In some embodiments, the semi-circular arc-shaped second channel has a rectilinear segment, and it can be seen that the second channel is not regularly semi-circular arc-shaped, but approximately semi-circular arc-shaped through creative design, which can help to reduce the flow resistance and improve the mixing effect.

Further, a length of the initial segment is less than or equal to ⅓ of a length of the second channel. The rectilinear segment cannot be too long, otherwise the mixing effect will be affected and therefore needs to be controlled within ⅓ of a length of the second channel. A “curvilinear channel” refers to a channel included in the second channel, which is curvilinear, can be either a curve with continuous arcs or a curve with a fixed arc, such that the curve can be, for example, a serpentine curve or the shape of some of the channels as shown in FIG. 15. In FIG. 15, the rectilinear shape is related to a rectilinear channel, and the curvilinear shape is related to a curvilinear channel. The curvilinear channel herein refers to that part of the second path is curvilinear, of course it can be understood that the second path itself is totally or wholly curvilinear with respect to the rectilinear path. Correspondingly, a rectilinear channel does not mean that all channels are rectilinear, but may include curvilinear channels in the rectilinear channel, such that the length can be reduced. In general, fluids with different fluid flow characteristics, such as velocity, path length of flow, volume of flow per unit time, etc. are allowed to flow in the two channels.

Further, the mixer includes two or more mixing units, and each of the mixing units is connected head to end; two adjacent mixing units are a mixing unit A and a mixing unit B, the second channel of the mixing unit A is positioned on a right side of the first channel, and the second channel of the mixing unit B is positioned on a left side of the first channel.

Each of the mixing units is connected head to end, which means that the head of the mixing unit A is connected to the end of the mixing unit B, and the mixing units are connected together in series. However, the semi-circular arc directions of the adjacent mixing units A and B are opposite, such that the fluids flow in the same path during separation and recombination, but the flow directions are opposite, the turbulences and the vortexes generated are also opposite, and therefore the impact force encountered is changed regularly, such that the fluids are mixed more uniformly and stably.

Further, all channels have the same width. Because the widths of the channels are consistent and are not changed obviously, the fluid is not easy to be blocked by foreign matters in the mixing process. In some embodiments, the size or cross-sectional area or a channel section of the mixing unit is the same, such that such a microparticle channel can be manufactured more easily, simply by changing the shape of the channel. The depth, width, or cross-sectional area, etc. herein may allow the two channels to be consistent, but the alternatives that do not maintain consistency are not precluded.

Further, the first channel (rectilinear channel) of each of the mixing units is in rectilinear communication with an initial segment of the second channel (including a curvilinear channel) of the next mixing unit. This further helps to reduce the flow resistance and improve the mixing effect.

Furthermore, the channel section of the mixer provided by the present invention is rectangular, and lengths and widths of the sections of all channels are uniform. The section of a channel of the mixer can be made into various shapes as required, such as a circle, a semicircle, a square, a rectangle, a triangle, a trapezoid and the like, and the channel section of the mixer is preferably a rectangle or a square for convenience of manufacture.

Further, the mixer includes six mixing units connected in series in the same manner as the first mixing unit and the second mixing unit. Further enhancement of the mixing effect can also be achieved by a series connection of more mixing units.

It can be proved by multiple experiments carried out by a research group that the mixing conduit containing 6 mixing units for preparing the nanoparticle can completely meet the requirement for mixing effect of preparing the nanoparticle. The invention therefore preferably employs a mixer including six mixing units. This is merely a preferred solution, and does not mean that a single mixing unit cannot be implemented, and that a flow path can be extended, and the mixer may consist of two or more mixing units connected in series.

Further, it is also possible to carry out a series connection of a plurality of mixers to improve a mixing effect according to a need for preparing a product. Multiple mixers can also be connected in series or in parallel into the microfluidic hybrid chip cartridge. In certain embodiments, a second mixer is included. Other inlet connections may also be added to support the function of additional mixers. In one Example, a plurality of mixers may be included in the chip.

In still other embodiments, a third inlet connection is included and a second mixer is included to dilute the mixed solution produced by the first mixer by mixing the diluted solution provided via the third inlet connector.

“Incorporated . . . in its entirety” in the mixer is incorporated into the chip in its entirety means that the mixer structure cannot be easily removed from the chip. For example, provided that the chip can only be opened with a tool, such as a screwdriver for loosening set screws, in order to expose the mixer structure, the mixer is incorporated into the chip in its entirety. Additionally, provided that the chip is sealed to be closed such that the mixer can only be removed by breaking same, the mixer can be incorporated into the chip in its entirety. In still other embodiments, provided that the mixer is physically attached or part of the chip (e.g., the microfluidic hybrid chip cartridge is of unitary configuration or has been permanently attached using adhesives, solvent soldering, or other techniques), the mixer can be incorporated into the chip in its entirety. The overall configuration described above is not considered to be incorporated into the chip because the mixer is part of the chip, which provides functions other than microfluidic flow (e.g., structural support).

In yet another example, incorporation in its entirety means that the microfluidic hybrid chip cartridge cannot be disassembled and reassembled together. For example, the mixer cannot be removed from the chip and then replaced and sealed.

### Cartridge Material and Configuration

The chip and microfluidic structure are formed from materials capable of forming the desired shape and having the desired physical characteristics. The material of the microfluidic structure is capable of forming the required microscale mixing channels and of withstanding the pressure exerted during mixing in the microfluidic structure. The material of the chip is sufficiently rigid that it will protect and support the microfluidic structures within the chip.

In one Example, the microfluidic structure and chip are formed from different materials. In yet another example, the microfluidic structure and the chip are formed from the same material. In yet another example, the microfluidic structure and the chip are integrally formed.

In one Example, the chip is free of metal. In yet another example, the chip may contain some metal, but at least 90% by weight of the chip is a polymer. In one Example, the chip is free of metal. In yet another example, the chip may contain some metal, but at least 99% by weight of the chip is a polymer.

In one Example, the chip includes a polymer selected from the group consisting of polypropylene, polycarbonate, COC, COP, polystyrene, nylon, acrylic polymers, HPDE, LPDE, and other polyolefins.

In one Example, the chip does not include metal on the outer surface. It can be contemplated in the embodiments that magnets or other metal-containing elements may be present within the chip, but not on the outer surface.

In yet another example, the first inlet connector and the second inlet connector are formed from a polymer. It is preferred in certain embodiments that the inlet connector be formed from a relatively soft polymeric material, particularly where tapered connectors or Luer connectors are used. A softer polymer will improve the secondary manufacturing error of the inlet and allow the formation of a liquid-tight connection. A more rigid polymer will not allow the fault tolerance feature described above. In this aspect, in one Example, the first inlet connector includes a polymer having a Young's modulus of 500 MPa to 3500 MPa. In one Example, the first inlet connector includes a polymer having a Young's modulus of 2000 MPa to 3000 MPa.

In one Example, the chip includes a metal selected from the group consisting of aluminum and steel. As described above, in certain embodiments, a small amount of metal can be incorporated into the chip.

In one Example, the microfluidic structure is inseparable from the chip. In such embodiments, the microfluidic structure is attached (e.g., welded or attached) to at least a portion of the carrier. In one Example, the microfluidic hybrid chip cartridge is of unitary configuration, wherein the chip and the microfluidic structure are formed from the same material. In yet another example, the microfluidic hybrid chip cartridge consists of at least two portions, such as a connecting portion and a top plate, wherein the microfluidic structure incorporates one of the two portions. That is, the microfluidic structure is attached (e.g., bonded or soldered) to a portion of the microfluidic hybrid chip cartridge that performs an additional function beyond providing microfluidic elements. In one Example, the microfluidic structure is connected to the top plate. In yet another example, the microfluidic structure and the top plate are monolithic and formed from the same material. In yet another example, the microfluidic structure is of unitary configuration with one of the two parts.

In one Example, the chip surrounds the microfluidic structure. As used herein, the term “surround” refers to a chip surrounding a substantial portion of a surface area of the mixer. Most importantly, the chip facilitates a fluid-tight seal with the microfluidic structure and provides a rigid chamber that allows manipulation of the microfluidic hybrid chip cartridge. In yet another example, the chip completely surrounds the microfluidic structure, which means that no surface area of the microfluidic structure is exposed outside the carrier. The embodiments are illustrated in FIGS. 1A-3.

In one Example, the first portion and the second portion are joined together to surround the microfluidic structure.

In one Example, at least 90% by weight of the first portion is a polymer. In this Example, the first portion includes an inlet connector and an outlet opening.

In one Example, the first portion or the second portion includes a microfluidic structure. In such embodiments, the microfluidic structure is attached to or integrated with the first or second portion of the chip.

### Fluid Source

Fluids or solution reservoir are selected to make it possible to connect directly to the microfluidic hybrid chip cartridge. In one Example, the fluid reservoir is a disposable syringe. In yet another example, the fluid reservoir is a pre-filled syringe. Both the fluid and the reservoir may be sterile to produce a sterile nanoparticle. The system contains an apparatus by which a fluid flows from the reservoir and through the cartridge at a specified flow rate. In one Example of the system, a reservoir is pressurized to flow a fluid, such that the first and second fluids enter the cartridge (the fluids enter a microfluidic structure and its channels through an inlet). Embodiments of pressurizing devices include, but are not limited to, rectilinear actuators and inert gases. In one Example, each reservoir is independently pressurized. In one Example, two or more reservoirs are pressurized by the same source, while different flow rates are obtained by varying dimensions of the fluid channels. Differential flow rates may be made possible by different pressure drops, differential channel impedance, or a combination thereof applied to the inlet stream across the fluid channels. Different flow rates can be obtained by varying the different channel impedance of a height, a width, a length or surface characteristics of the channel. Different flow rates can be obtained by using or considering fluid surface tension, viscosity, and other surface characteristics of the fluid in one or more first streams and one or more second streams. Container pressurization may be controlled by a computer or microcontroller.

In certain embodiments, the system further includes means for full or partial system purging to minimize waste volume. After or during preparation of particles, purging may be accomplished by flowing a gas or liquid through a linker and a microfluidic structure. Gases such as air, nitrogen, argon and the like may be used. Liquids may be used including water, aqueous buffers, ethanol, oil, or any other liquid.

### Fixing Mechanism

In one Example, the microfluidic hybrid chip cartridge further includes a securing mechanism configured to secure a microfluidic hybrid chip cartridge to a holder. In one Example, the holder is a device configured to arrange the microfluidic hybrid chip cartridge relative to a fluid source (e.g., a syringe) and facilitate connection therebetween.

### Asepsis

Sterile cartridges are necessary for certain applications and provide a convenient workflow for a user to formulate a sterile nanoparticle directly without further filtration or processing. The above workflow minimizes substance loss associated with further sterilization steps. In one Example, individual components of a cartridge are sterilized before assembly. Representative sterilization methods include steam autoclaves, dry heating, chemical sterilization (i.e., sodium hydroxide or ethylene oxide), γ radiation, gases, and combinations thereof. In a particular embodiment, a microfluidic structure, an inlet connector, an outlet connector, and any other fluid contacting components are formed from a material compatible with γ radiation and sterilized by such means. Materials compatible with γ radiation are those capable of being irradiated. For example, polycarbonates, cyclic olefin polymers, cyclic olefin copolymers, polypropylene, and high and low density polyethylene. Materials that cannot be irradiated include polyamide, polytetrafluoroethylene, and any metal. In yet another example, a cartridge is sterilized after assembly.

In one Example, the cartridge is sterilizable. As used herein, the term “sterilizable” means that the cartridge is formed from a material compatible with known sterilization methods, as previously described. In one Example, the cartridge is specifically sterilizable by γ radiation. In yet another example, the cartridge is formed from a polymer selected from the group consisting of polypropylene, polycarbonate, cyclic olefin polymers, cyclic olefin copolymers, high density polyethylene, low density polyethylene, and combinations thereof. In yet another example, the cartridge does not include polyamide, polytetrafluoroethylene, or any metal.

In one Example, a microfluidic hybrid chip cartridge is sterile.

In one Example, a microfluidic hybrid chip cartridge includes a sterile fluid path from a first inlet connector and a second inlet connector, through a microfluidic structure, and to an outlet opening. The sterile fluid path described above allows mixing in a sterile environment. Since the inlet connector and the outlet opening are also sterile, a sterile connection can easily be made possible.

In yet another aspect, a sterile package filled with sterile contents is provided. In one Example, the sterile package including a microfluidic cartridge according to any one of the embodiments disclosed herein is in a sterile state and sealed within the sterile package. The sterile package is defined by a housing containing sterile contents. The housing in one Example is a bag. By providing a microfluidic hybrid chip cartridge that is sterile and sealed within a sterile package, an end user can easily carry out sterile microfluidic mixing with the cartridge: the sterile package is opened in a sterile environment and used for mixing without any preparation. Sterilization is not required for any sterile inlet connector or fluid path.

In one Example, the sterile package further includes a first sterile syringe configured to couple with the first inlet connector of the microfluidic cartridge. In this Example, the sterile package is a kit including a microfluidic cartridge and a sterile syringe configured for use with the microfluidic cartridge. In one Example, the sterile package further includes a first solution in a first sterile syringe.

In one Example, the first solution includes nucleic acid in a first solvent. In yet another example, the first solution is configured to form a lipid nanoparticle.

In one Example, the sterile package further includes a second sterile syringe configured to couple with the second inlet connector of the microfluidic cartridge.

In one Example, the sterile package further includes a second solution in a second sterile syringe.

In one Example, the second solution includes a lipid particle-forming material in a second solvent. The second solution can be combined with a first solution including nucleic acid in a first solvent to form a lipid nanoparticle solution via a microfluidic cartridge.

In one Example, the sterile package further includes a sterile container configured to couple with an outlet opening of the microfluidic cartridge via an outlet opening connector.

In one Example, the sterile contents are disposable.

### Nanoparticle

The nanoparticle described herein is a homogeneous particle including more than one component (e.g., lipid, polymer, etc.) that is used to encapsulate a therapeutic substance and has a minimum dimension of less than 250 nanometers. A nanoparticle includes, but is not limited to, lipid nanoparticle and polymer nanoparticle.

### Lipid Nanoparticle

In one Example, a lipid nanoparticle includes: (a) a core; and (b) a shell surrounding the core, wherein the shell includes a phospholipid. Of course, it can also be a lipid-encapsulated nucleic acid substance.

In one Example, the core includes a lipid (e.g., a fatty acid triglyceride) and is a solid. In yet another example, the core is a liquid (e.g., aqueous) and the particle is a vesicle such as a liposome. In one Example, the shell surrounding the core is single-layered.

As described above, in one Example, the lipid core includes a fatty acid triglyceride. A suitable fatty acid triglyceride includes a C₈-C₂₀ fatty acid triglyceride. In one Example, the fatty acid triglyceride is an oleic triglyceride.

The lipid nanoparticle includes a shell including a phospholipid, the shell surrounding a core. Suitable phospholipids include diacylphosphatidylcholine, diacylphosphatidylethanolamine, ceramide, sphingomyelin, dihydrosphingomyelin, cephalin, and cerebroside. In one Example, the phospholipid is a C₈-C₂₀ fatty acid diacylphosphatidylcholine. A representative phospholipid is 1-palmitoyl-2-oleoylphosphatidylcholine (POPC).

In certain embodiments, a ratio of phospholipid to fatty acid triglyceride is from 20:80 (mol:mol) to 60:40 (mol:mol). Preferably, triglycerides are present in a ratio of greater than 40% and less than 80%.

In certain embodiments, the nanoparticle further includes a sterol. Representative sterols include cholesterol. In one Example, the ratio of phospholipid to cholesterol is 55:45 (mol:mol). In a representative Example, the nanoparticle includes 55-100% of POPC and up to 10 mol % of PEG-lipid.

In other embodiments, the lipid nanoparticle of the present disclosure may include one or more other lipids, including phosphoglycerides, representative embodiments of which include phosphatidylcholine, phosphatidylethanolamine, phosphatidylserine, phosphatidylinositol, phosphatidic acid, palmitoyloleoylphosphatidylcholine, lysylphosphatidylcholine, lysophosphatidylethanolamine, dipalmitoylphosphatidylcholine, dioleoylphosphatidylcholine, distearoylphosphatidylcholine, and dioleoylphosphatidylcholine. Other compounds lacking phosphorus such as sphingolipids and glycosphingolipids are useful. Triacylglycerols are also useful.

A representative nanoparticle of the present disclosure has a diameter of about 10 to about 100 nm. A lower limit of the diameter is about 10 to about 15 nm.

The lipid nanoparticle of the present disclosure with a limited size can include one or more therapeutic and/or diagnostic agents. These agents are generally contained within the particle core. The nanoparticle of the present disclosure can include a wide variety of therapeutic and/or diagnostic agents.

Suitable therapeutic agents include chemotherapeutic agents (i.e., antineoplastic agents), anesthetics, β-adrenergic blockers, antihypertensives, antidepressants, anticonvulsants, antiemetics, antihistamines, antiarrhythmics, and antimalarials.

Representative antineoplastic agents include doxorubicin, daunorubicin, mitomycin, bleomycin, streptozocin, vinblastine, vincristine, nitrogen mustard, hydrochloride, melphalan, cyclophosphamide, triethylenethiophosphoramide, carmustine, lomustine, semustine, fluorouracil, hydroxyurea, thioguanine, cytarabine, floxuridine, amidoximine, cisplatin, procarbazine, vinorelbine, ciprofloxacin, norfloxacin, paclitaxel, docetaxel, etoposide, bexarotene, teniposide, tretinoin, isotretinoin, sirolimus, fulvestrant, valrubicin, vindesine, leucovorin, irinotecan, capecitabine, gemcitabine, mitoxantrone hydrochloride, oxaliplatin, doxorubicin, methotrexate, carboplatin, estramustine, and pharmaceutically acceptable salts thereof.

In yet another example, a lipid nanoparticle is a nucleic acid-lipid nanoparticle.

The nucleic acid-lipid nanoparticle refers to a lipid nanoparticle containing a nucleic acid. The lipid nanoparticle includes one or more cationic lipids, one or more second lipids, and one or more nucleic acids.

The lipid nanoparticle includes a cationic lipid. A cationic lipid refers to a lipid that is a cation or becomes a cation (protonated) as the pH decreases below an ionizable group pK of the lipid, but gradually becomes more neutral at higher pH values. At a pH value below pK, a lipid can then bind to a negatively charged nucleic acid (e.g., oligonucleotide). The cationic lipid includes a zwitterionic lipid that is positively charged when the pH decreases.

The cationic lipid refers to any of a number of lipid species that carry a net positive charge at a selective pH, such as a physiological pH. Such lipid includes, but is not limited to, N,N-dioleyl-N,N-dimethylammonium chloride (DODAC); N-(2,3-dioleyloxy) propyl)-N, N,N-trimethylammonium chloride (DOTMA); N,N-distearyl-N,N-dimethylammonium bromide (DDAB); N-(2,3-dioleoyloxy) propyl)-N,N,N-trimethylammonium chloride (DOTAP); 3-(N—(N′,N′-dimethylaminoethane)-carbamoyl) cholesterol (DC-Chol) and N-(1,2-dimyristyloxypropan-3-yl)-N,N-dimethyl-N-hydroxyethylammonium bromide (DMRIE). Additionally, there are many commercial formulations of cationic lipids that can be used in the present disclosure. These include, for example, (a commercially available cationic liposome containing DOTMA and 1,2-dioleoyl-sn-3-phosphoethanolamine (DOPE) from GIBCO/BRL, Grand Island, N.Y.); (a commercially available cationic liposome containing N-(1-(2,3-dioleyloxy) propyl)-N-(2-(spermidine carcartridgeamido) ethyl)-N,N-dimethylammonium trifluoroacetate (DOSPA) and (DOPE) from GIBCO/BRL); and (a commercially available cationic lipid containing dioctadecylamidoglycylcarcartridgeyspermine (DOGS) in ethanol from Promega Corp., Madison, Wis.). The following lipids are cations and have a positive charge at physiological pH: DODAP, DODMA, DMDMA, 1,2-diolefinenyloxy-N,N-dimethylaminopropane (DLinDMA), 1,2-dillenenyloxy-N,N-dimethylaminopropane (DLenDMA).

In one Example, the cationic lipid is an amino lipid. Amino lipids suitable for use in the disclosure include those described in WO 2009/096558, which is incorporated herein by reference in its entirety. Representative amino lipids include 1,2-dioleylideneoxy-3-(dimethylamino) acetoxypropane (DLin-DAC), 1,2-dioleylideneoxy-3-morpholinopropane (DLin-MA), 1,2-dioleylidene-3-dimethylaminopropane (DLinDAP), 1,2-dioleylidenethio-3-dimethylaminopropane (DLin-S-DMA), 1-linoleoyl-2-linoleyloxy-3-dimethylaminopropane (DLin-2-DMAP), 1,2-dioleylideneoxy-3-trimethylaminopropane chloride (DLin-TMA. Cl), 1,2-dioleyl-3-trimethylaminopropane chloride salt (DLin-released Cl), 1,2-dioleylideneoxy-3-(N-methylpiperazino) propane (DLin-MPZ), 3-(N,N-dioleylideneamino)-1,2-propanediol (DLINAP), 3-(N,N-dioleylideneamino)-1,2-propanediol (DOAP), 1,2-dioleylideneoxo-3-(2-N,N-dimethylamino) ethoxypropane (DLin-EG-DMA), and 2,2-dioleylidene-4-dimethylaminomethyl[1,3]-dioxolane (DLin-K-DMA).

Suitable amino lipids include those having the formula:

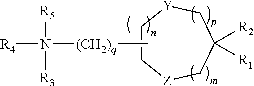

wherein R¹ and R² are the same or different and are independently optionally substituted C₁₀-C₂₄ alkyl, optionally substituted C₁₀-C₂₄ alkenyl, optionally substituted C₁₀-C₂₄ alkynyl, or optionally substituted C₁₀-C₂₄ acyl; R³ and R⁴ are the same or different and are independently optionally substituted C₁-C₆ alkyl, optionally substituted C₂-C₆ alkenyl, or optionally substituted C₂-C₆ alkynyl; or R³ and R⁴ may be joined to form an optionally substituted heterocyclic ring having 4 to 6 carbon atoms and 1 or 2 heteroatoms selected from nitrogen and oxygen; R⁵ is absent or present, and it is hydrogen or C₁-C₆ alkyl when present; m, n and p are the same or different and are independently 0 or 1, provided that m, n and p are not simultaneously 0; q is 0, 1, 2, 3 or 4; and Y and Z are the same or different and are independently O, S or NH.

In one Example, R¹ and R² are each a linoleyl, and an amino lipid is a diolefinenyl amino lipid. In one Example, the amino lipid is a dilinoleyl amino lipid.

Representative useful diolefinenylaminolipids have the formula:

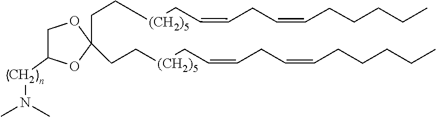

wherein n is 0, 1, 2, 3 or 4.

In one Example, the cationic lipid is DLin-K-DMA. In one Example, the cationic lipid is DLin-KC2-DMA (DLin-K-DMA described above, wherein n is 2).

In addition to those specifically described above, other suitable cationic lipids include cationic lipids which carry a net positive charge at about physiological pH: N,N-dioleyl-N,N-dimethylammonium chloride (DODAC); N-(2,3-dioleyloxy) propyl-N,N—N-triethylammonium chloride (DOTMA); N,N-distearyl-N,N-dimethylammonium bromide (DDAB); N-(2,3-dioleoyloxy) propyl)-N,N-trimethylammonium chloride (DOTAP); 1,2-dioleyloxy-3-trimethylaminopropane chloride salt (DOTAP Cl); 3β-(N′,N′-dimethylaminoethane) carbamoyl) cholesterol (DC-Chol), N-(1-(2,3-dioleoyloxy) propyl)-N-2-(sperminoylamido) ethyl)-N,N-dimethylammonium trifluoroacetate (DOSPA), dioctadecyl amidoglycylcarboxy spermine (DOGS), 1,2-dioleoyl-3-dimethylammoniumpropane (DODAP), N,N-dimethyl-2,3-dioleoyloxy) propylamine (DODMA), and N-(1,2-dimyristoyloxypropan-3-yl)-N,N-dimethyl-N-hydroxyethylammonium bromide (DMRIE). Additionally, many commercial formulations of cationic lipids can be used, such as LIPOFECTIN (including DOTMA and DOPE available from GIBCO/BRL), and LIPOFECTAMINE (including DOSPA and DOPE available from GIBCO/BRL).

The cationic lipid is present in the lipid particle in an amount of about 30 to about 95 mole percent. In one Example, the cationic lipid is present in the lipid particle in an amount of about 30 to about 70 mole percent. In one Example, the cationic lipid is present in the lipid particle in an amount of about 40 to about 60 mole percent.

In one Example, the lipid particle includes one or more cationic lipids and one or more nucleic acids.

In certain embodiments, the lipid nanoparticle includes one or more second lipids. Suitable second lipids stabilize nanoparticle generation.

Lipids refer to a class of organic compounds that are esters of fatty acids and are characterized by being insoluble in water but soluble in many organic solvents. Lipids are generally classified into at least three categories: (1) “simple lipids”, which include fats and oils and waxes; (2) “compound lipids”, which include phospholipids and glycolipids; and (3) “derivatized lipids” such as steroids.

Suitable stabilizing lipids include neutral lipids and anionic lipids.

A neutral lipid refers to any of a number of lipid species that exist in uncharged or neutral zwitterionic form at physiological pH. Representative neutral lipids include diacylphosphatidylcholine, diacylphosphatidylethanolamine, ceramide, sphingomyelin, dihydrosphingomyelin, cephalin, and cerebroside.

Exemplary lipids include, for example, distearoylphosphatidylcholine (DSPC), dioleoylphosphatidylcholine (DOPC), dipalmitoylphosphatidylcholine (DPPC), dioleoylphosphatidylglycerol (DOPG), dipalmitoylphosphatidylglycerol (DPPG), dioleoyl-phosphatidylethanolamine (DOPE), palmitoyl oleoylphosphatidylcholine (POPC), palmitoyl oleoyl-phosphatidylethanolamine (POPE) and dioleoyl-phosphatidylethanolamine 4-(N-maleimidomethyl)-cyclohexane-1-carcartridgeylate (DOPE-mal), dipalmitoylphosphatidylethanolamine (DPPE), dimyristoylphosphatidylethanolamine (DMPE), distearoyl-phosphatidylethanolamine (DSPE), 16-O-monomethyl PE, 16-O-dimethyl PE, 18-1-trans PE, 1-stearoyl-2-oleoyl-phosphatidylethanolamine (SOPE), and 1,2-dioleoyl-sn-glycero-3-phosphoethanolamine (trans DOPE).

In one Example, the neutral lipid is 1,2-distearoyl-sn-glycero-3-phosphocholine (DSPC). An anionic lipid refers to any lipid that is negatively charged at physiological pH. These lipids include phosphatidylglycerol, cardiolipin, diacylphosphatidylserine, diacylphosphatidylic acid, N-dodecanoyl phosphatidylethanolamine, N-succinyl phosphatidylethanolamine, N-glutaryl phosphatidylethanolamine, lysyl phosphatidylglycerol, palmitoyl oleoyl phosphatidylglycerol (POPG), and other anionic modifying groups attached to neutral lipids.

Other suitable lipids include glycolipids (e.g., monosialoganglioside GM1). Other suitable second lipids include sterols such as cholesterol.

In certain embodiments, the second lipid is a polyethylene glycol-lipid. Suitable polyethylene glycol-lipids include PEG-modified phosphatidylethanolamine, PEG-modified phosphatidic acid, PEG-modified ceramide (e.g., PEG-CerC₁₄ or PEG-CerC₂₀), PEG-modified dialkylamine, PEG-modified diacylglycerol, and PEG-modified dialkylglycerol. Representative polyethylene glycol-lipids include PEG-c-DOMG, PEG-c-DMA, and PEG-s-DMG. In one Example, the polyethylene glycol-lipid is N-(methoxypoly (ethylene glycol) 2000) carbamoyl-1,2-dimyristyloxypropyl-3-amine (PEG-c-DMA). In one Example, the polyethylene glycol-lipid is PEG-c-DOMG).

In certain embodiments, the second lipid is present in the lipid particle in an amount of about 0.5 to about 10 mole percent. In one Example, the second lipid is present in the lipid particle in an amount of about 1 to about 5 mole percent. In one Example, the second lipid is present in the lipid particle in about 1 mole percent.

The lipid nanoparticle disclosed herein can be used for systemic or local delivery of a nucleic acid. As described herein, the nucleic acid is incorporated into the lipid particle during formation of same.

Of course, such nanoparticle may also be core-shell structured particle, if the nucleic acid is mixed with the polymer to form a core and then the liposome is encapsulated outside the core structure, or may be accomplished by the mixer of the present invention. The nucleic acid and polymer may be first formed into a microparticle structure by a mixer, and then the microparticle and lipid components may be formed into a microparticle structure by the mixer. Such a core-shell structure, e.g. all core materials and shell materials in a Patent Application No. 201880001680.5 can be formed with the mixer of the present invention, all core-constituting materials and shell-forming materials of which are an implementation of the present invention.

### Nucleic Acid

A nucleic acid includes any oligonucleotide or polynucleotide. A fragment containing up to 50 nucleotides are generally referred to as an oligonucleotide, while a longer fragment is referred to as a polynucleotide. In a particular embodiment, the oligonucleotide consists of 20-50 nucleotides in length. In the present invention, the polynucleotide and the oligonucleotide refer to a polymer or oligomer of a nucleotide or a nucleoside monomer consisting of trona, carbohydrates and intersaccharide (backbone) linkages. Polynucleotides and oligonucleotides also include polymers or oligomers including non-natural monomers or portions thereof, which function similarly. Such modified or substituted oligonucleotides are often preferred over native forms because of enhanced cellular uptake properties and increased stability in the presence of nucleases. Oligonucleotides are defined as deoxyribonucleotides or ribonucleotides. Deoxyribonucleotides consist of a 5-carbon sugar referred to as deoxyribose, which is covalently linked at the 5′ and 3′ carbons to a phosphate ester, to form an alternating and unbranched polymer. Ribonucleotides consist of similar repeating structures in which the 5-carbon sugar is ribose. Nucleic acids present in the lipid particle according to the present disclosure include any known form of nucleic acid. As used herein, a nucleic acid can be single-stranded DNA or RNA, or double-stranded DNA or RNA, or a DNA-RNA hybrid. Embodiments of double-stranded DNA include structural genes, genes including control and termination regions, and self-replicating systems such as viral or plasmid DNA. Embodiments of double-stranded RNA include siRNA and other RNA interfering agents. Single-stranded nucleic acids include antisense oligonucleotides, ribozymes, microRNAs, mRNAs, and triplex oligonucleotides.

In one Example, the polynucleic acid is an antisense oligonucleotide. In certain embodiments, the nucleic acid is an antisense nucleic acid, ribozyme, tRNA, snRNA, siRNA, shRNA, ncRNA, miRNA, mRNA, lncRNA, sgRNA, precondensed DNA, or aptamer.

Nucleic acid also refers to a nucleotide, a deoxynucleotide, a modified nucleotide, a modified deoxynucleotide, a modified phosphate-sugar-backbone oligonucleotide, other nucleotides, nucleotide analogs, and combinations thereof, and can optionally be single-stranded, double-stranded, or contain portions of double-stranded and single-stranded sequences.

A nucleotide generally encompasses the following terms as defined below: a nucleotide base, a nucleoside, a nucleotide analog, and a general nucleotide.

A nucleotide base refers to a substituted or unsubstituted parent aromatic monocyclic or polycyclic ring. In certain embodiments, the aromatic monocyclic or polycyclic ring contains at least one nitrogen atom. In certain embodiments, the nucleotide bases are capable of forming Watson-Crick and/or Hoogsteen hydrogen bonds with appropriately complementary nucleotide bases. Exemplary nucleotide bases and analogs thereof include, but are not limited to, purines such as 2-aminopurine, 2,6-diaminopurine, adenine (A), vinylidene adenine, N6-2-isopentenyladenine (6iA), N6-2-isopentenyl-2-methylthioadenine (2ms6iA), N6-methyladenine, guanine (G), isoguanine, N2-dimethylguanine (dmG), 7-methylguanine (7 mG), 2-thiopyrimidine, 6-thioguanine (6sG) hypoxanthine, and 06-methylguanine; 7-deaza-purines such as 7-deazaadenine (7-deaza-A) and 7-deazaguanine (7-deaza-G); pyrimidines such as cytosine (C), 5-propynylcytosine, isocytosine, thymine (T), 4-thiothymine (4sT), 5,6-dihydrothymine, O4-methylthymidine, uracil (U), 4-thiouracil (4sU) and 5,6-dihydrouracil (dihydrouracil; D); indoles such as nitroindole and 4-methylindole; pyrroles such as nitropyrroles; nebularine; a base (Y); in certain embodiments, the nucleotide base is generally a nucleotide base. Additional exemplary nucleotide bases can be found in Fasman, 1989, Practical Handbook of Biochemistry and Molecular Biology, pp. 385-394, CRCPress, BocaRaton, Fla. and references cited therein. Further embodiments of general bases can be found, for example, in Loakes, N.A.R. 2001, vol 29: 2437-2447 and Seela N.A.R. 2000, vol 28: 3224-3232.

Nucleosides refer to compounds having a nucleotide base covalently attached to the C-1′ carbon of a pentose. In certain embodiments, the linkage is formed via a heteroaromatic ring nitrogen. Typical pentoses include, but are not limited to those in which one or more of the carbon atoms are each independently substituted with one or more identical or different-R, —OR, —NRR, or halogen groups, wherein each R is independently hydrogen, (C₁-C₆) alkyl, or (C₅-C₁₄) aryl. Pentoses may be saturated or unsaturated. Exemplary pentoses and analogs thereof include, but are not limited to, ribose, 2′-deoxyribose, 2′-(C₁-C₆) alkyloxyribose, 2′-(C₅-C₁₄) aryloxyribose, 2′,3′-dideoxyribose, 2′,3′-didehydroribose, 2′-deoxy-3′-haloribose, 2′-deoxy-3′-fluororibose, 2′-deoxy-3′-chlororibose, 2′-deoxy-3′-aminoribose, 2′-deoxy-3′-(C₁-C₆) alkylribose, 2′-deoxy-3′-(C₁-C₆) alkyloxyribose and 2′deoxy-3′-(C₅-C₁₄) aryloxyribose. Also see, e.g., 2′-O-methyl, 4′-. α.-anomeric nucleotides, 1′-. α.-anomeric nucleotides (Asseline (1991) Nucl. Acids Res. 19: 4067-74), 2′-4′- and 3′-4′-linked and other “locked” or “LNA” bicyclic sugar modifications (WO 98/22489; WO 98/39352; WO 99/14226).” “An LNA” or “locked nucleic acid” is a conformationally locked DNA analog in which the ribose ring is constrained by a methylene group attached between the 2′-oxygen and the 3′- or 4′-carbon. The conformation constraints imposed by this linkage often increase the binding affinity of the complementary sequences and increase thermal stability of the duplex.

Carbohydrates include modifications at a 2′-position or 3′-position such as methoxy, ethoxy, allyloxy, isopropoxy, butoxy, isobutoxy, methoxyethyl, alkoxy, phenoxy, azido, amino, alkylamino, fluoro, chloro and bromo. Nucleosides and nucleotides include a natural D-isomer (D-form), and a L-isomer (L-form) (Beigelman, U.S. Pat. No. 6,251,666; Chu, U.S. Pat. No. 5,753,789; Shudo, EP 0540742; Garbesi (1993) Nucl. Acids Res. 21: 4159-65; Fujimori (1990) J. Amer. Chem. Soc. 112: 7435; Urata, (1993) Nucleic Acids Symposium Ser. No. 29: 69-70). In the case where the nucleobase is a purine, such as A or G, a ribose is attached to a N9-position of the nucleobase. Where the nucleobase is pyrimidine, for example C, T or U, the pentose sugar is attached to the N1-position of the nucleobase (Kornberg and Baker, (1992) DNA Replication, 2nd Ed., Freeman, San Francisco, Calif.).

One or more of the nucleoside pentose carbons may be substituted with a phosphate ester. In certain embodiments, the phosphate ester is attached to the pentose 3′- or 5′-carbon. In certain embodiments, the nucleosides are those in which the nucleotide bases are purines, 7-deazapurines, pyrimidines, general nucleotide bases, specific nucleotide bases, or analogs thereof.

Nucleotide analogs are those in which one or more of the pentoses and/or nucleotide bases and/or nucleoside phosphates may be replaced with their respective analogs. In certain embodiments, exemplary pentose analogs are those described above. In certain embodiments, the nucleotide analogs have the nucleotide base analogs described above. In certain embodiments, exemplary phosphate analogs include, but are not limited to, alkyl phosphonates, methyl phosphonates, phosphoramidates, phosphotriesters, phosphorothioates, phosphorodithioates, selenophosphates, phosphorodiselenates, phosphoroanilothioates, phosphoroanilates, phosphoramidates, borono phosphates, and may include bound counterions. Other nucleic acid analogs and bases include, for example, intercalated nucleic acids (INAs, described in Christensen and Pedersen, 2002), and AEGIS bases (Eragen, U.S. Pat. No. 5,432,272). Additional descriptions of various nucleic acid analogs can also be found, for example in (Beaucage et al., Tetrahedron 49(10):1925(1993) and references therein; Letsinger, J. Org. Chem. 35: 3800(1970); Sprinzl et al., Eur. J. Biochem. 81: 579(1977); Letsinger et al., Nucl. Acids Res. 14: 3487(1986); Sawai et al, Chem. Lett. 805(1984), Letsinger et al., J. Am. Chem. Soc. 110: 4470(1988); and Pauwels et al., Chemica Scripta 26: 141 91986)), phosphorothioates (Mag et al., Nucleic Acids Res. 19: 1437 (1991); and U.S. Pat. No. 5,644,048. Other nucleic acid analogs include phosphorodithioates (Briu et al., J. Am. Chem. Soc. 111: 2321 (1989), O-methyl phosphoramidate linkages (see Eckstein, Oligonucleotides and Analogues: A Practical Approach, Oxford University Press), those with a cationic backbone (Denpcy et al., Proc. Natl. Acad. Sci. USA 92: 6097 (1995); those having a nonionic backbone (U.S. Pat. Nos. 5,386,023; 5,386,023; 5,637,684; 5,602,240; 5,216,141; and 4,469,863). Kiedrowshi et al., Angew. Chem. Intl. Ed. English 30: 423(1991); Letsinger et al., J. Am. Chem. Soc. 110: 4470(1988); Letsinger et al., Nucleoside & Nucleotide 13: 1597(194): Chapters 2 and 3, ASC Symposium Series 580, “Carbohydrate Modifications in Antisense Research”, Ed. Y. S. Sanghui and P. Dan Cook; Mesmaeker et al., Bioorganic & Medicinal Chem. Lett. 4: 395(1994); Jeffs et al., J. Biomolecular NMR 34: 17(1994); Tetrahedron Lett. 37: 743(1996)) and those having a non-ribose backbone, including those described in U.S. Pat. Nos. 5,235,033 and 5,034,506, and Chapters 6 and 7, ASC Symposium Series 580, “Carbohydrate Modifications in Antisense Research”, Ed. Y. S. Sanghui and P. Dan Cook. Nucleic acids containing one or more carbocyclic saccharides are also included in the definition of nucleic acids (see Jenkins et al., Chem. Soc. Rev. (1995) pp. 169-176). Several nucleic acid analogs are also described in Rawls, C&E News, Jun. 2, 1997, pp. 35.

A generic nucleotide base or generic base refers to an aromatic ring moiety which may or may not contain a nitrogen atom. In certain embodiments, a generic base may be covalently attached to a pentose C-1′ carbon to form a generic nucleotide. In certain embodiments, generally, the nucleotide base does not specifically from a hydrogen bond with another nucleotide base. In certain embodiments, generally, nucleotide bases form a hydrogen bond with nucleotide bases which are up to and include all nucleotide bases in a particular target polynucleotide. In certain embodiments, nucleotide bases may interact with adjacent nucleotide bases on the same nucleic acid strand by hydrophobic stacking. Typical nucleotides include, but are not limited to, deoxy-7-azaindole triphosphate (d7AITP), deoxyisoquinolone triphosphate (dlSTP), deoxypropynylisoquinolone triphosphate (dPICSTP), deoxymethyl-7-azaindole triphosphate (dM7AITP), deoxy ImPy triphosphate (dImPyTP), deoxy PP triphosphate (dPPTP), or deoxypropynyl-7-azaindole triphosphate (dP7AITP). Further embodiments of such general bases can be found in published U.S. application Ser. No. 10/290,672 and U.S. Pat. No. 6,433,134.

Polynucleotides and oligonucleotides are used interchangeably, which relates to single-stranded polymers and double-stranded polymers of nucleotide monomers, including 2′-deoxynucleotides (DNA) and nucleotides (RNA), linked by internucleotide phosphodiester linkage moieties such as 3′-5′ and 2′-5′, reverse linkages such as 3′-3′ and 5′-5′, branched structures, or internucleotide analogs. Polynucleotides have bound counterions such as H⁺, NH₄⁺, trialkylammonium, Mg₂⁺, Na⁺, etc. The polynucleotide may consist entirely of deoxynucleotides, entirely of nucleotides, or a chimeric mixture thereof. Polynucleotides may include internucleotides, nucleobases and/or sugar analogs. Polynucleotides generally range in size from several monomer units, e.g., 3-40 (commonly referred to more frequently in the art as oligonucleotides) up to thousands of monomer nucleotide units. Unless otherwise indicated, whenever a polynucleotide sequence is present, it is understood that the nucleotides are in a 5′ to 3′ sequence from left to right, wherein “A” represents deoxyadenosine, “C” represents deoxycytosine, “G” represents deoxyguanosine, and “T” represents thymidine, unless otherwise noted.

Nucleobases mean those natural and those non-natural heterocyclic moieties which are generally known to those using nucleic acid techniques or peptide nucleic acid techniques to thereby produce polymers capable of sequence-specific binding to nucleic acids. Non-limiting embodiments of suitable nucleobases include: adenine, cytosine, guanine, thymine, uracil, 5-propynyl-uracil, 2-thio-5-propynyl-uracil, 5-methylcytosine, pseudoisocytosine, 2-thiouracil and 2-thiothymine, 2-aminopurine, N9-(2-amino-6-chloropurine), N9-(2,6-diaminopurine), hypoxanthine, N9-(7-deaza-guanine), N9-(7-deaza-8-aza-guanine), and N8-(7-deaza-8-aza-adenine). Other non-limiting embodiments of suitable nucleobases include those described by Buchardt et al. (WO 92/20702 or WO 92/20703).

Nucleobase sequence means any fragment or aggregate of two or more fragments (e.g., an aggregate nucleobase sequence of two or more oligomer blocks) belonging to a polymer comprising nucleobase-containing subunits. Non-limiting embodiments of suitable polymers or polymer fragments include oligodeoxynucleotides (e.g., DNA), oligonucleotides (e.g., RNA), peptide nucleic acids (PNA), PNA chimeras, PNA combinatorial oligomers, nucleic acid analogs, and/or nucleic acid mimetics.

Polynucleotide chain refers to a completely single polymer chain including nucleobase subunits. For example, a single nucleic acid strand of a double-stranded nucleic acid is a polynuclear base strand. A nucleic acid is a polymer containing a nucleobase sequence, or a polymer fragment having a backbone formed from a nucleotide, or an analog thereof. Preferred nucleic acids are DNA and RNA.

Nucleic acid may also refer to a “peptide nucleic acid” or “PNA”, further refers to any oligomer or polymer fragment (e.g., block oligomer) including two or more PNA subunits (residues), but not nucleic acid subunits (or analogs thereof), including, but not limited to any of the oligomer or polymer fragments mentioned or claimed as peptide nucleic acids in U.S. Pat. Nos. 5,539,082, 5,527,675, 5,623,049, 5,714,331, 5,718,262, 5,736,336, 5,773,571, 5,766,855, 5,786,461, 5,837,459, 5,891,625, 5,972,610, 5,986,053 and 6,107,470, which is incorporated herein by reference in its entirety. “Peptide nucleic acid” or “PNA” is also suitable for any oligomer or polymer fragment including two or more subunits of a nucleic acid mimetic described in the following disclosure: Lagriffoul et al., Bioorganic & Medicinal Chemistry Letters, 4: 1081-1082(1994); Petersen et al., Bioorganic & Medicinal Chemistry Letters, 6: 793-796(1996); Diderichsen et al., Tett. Lett. 37: 475-478(1996); Fujii et al., Bioorg. Med. Chem. Lett. 7: 637-627(1997); Jordan et al., Bioorg. Med. Chem. Lett. 7: 687-690(1997); Krotz et al., Tett. Lett. 36: 6941-6944(1995); Lagriffoul et al., Bioorg. Med. Chem. Lett. 4: 1081-1082(1994); Diederichsen, U., Bioorganic & Medicinal Chemistry Letters, 7: 1743-1746(1997); Lowe et al, J. Chem. Soc. Perkin Trans. 1, (1997) 1: 539-546; Lowe et J. Chem. Soc. Perkin Trans. 11: 547-554(1997); Lowe et al., J. Chem. Soc. Perkin Trans. 11: 555-560(1997); Howarth et al., J. Org. Chem. 62: 5441-5450(1997); Altmann, K-H et al., Bioorganic & Medicinal Chemistry Letters, 7: 1119-1122(1997); Diederichsen, U., Bioorganic & Med. Chem. Lett., 8: 165-168(1998); Diederichsen et al., Angew. Chem. Int. Ed., 37: 302-305(1998); Cantin et al., Tett. Lett., 38: 4211-4214(1997); Ciapetti et al., Tetrahedron, 53: 1167-1176(1997); Lagriffoule et al., Chem. Eur. J., 3: 912-919(1997); Kumar et al., Organic Letters 3(9): 1269-1272(2001); and peptide-based nucleic acid mimetics (PENAMS), described in publication WO 96/04000 by Shah et al.

### Polymer Nanoparticle

A polymeric nanoparticle refers to a polymeric nanoparticle containing a therapeutic substance. A polymer nanoparticle has been developed from a wide range of materials includes, but is not limited to: synthesized homopolymers, such as polyethylene glycol, polylactide, polyglycolide, poly (lactide-co-glycolide), polyacrylic acid, polymethacrylate, polycaprolactone, polyorthoester, polyanhydride, polylysine, and polyethyleneimine; synthesized copolymers, such as poly (lactide-co-glycolide), poly (lactide)-poly (ethylene glycol), poly (lactide-co-glycolide)-poly (ethylene glycol), and poly (caprolactone)-poly (ethylene glycol); natural polymers, such as cellulose, chitin and alginate, and polymeric-therapeutic substance conjugates.

The polymer according to the present invention refers to a typically high molecular weight compound that is primarily or completely constructed from a number of similar units bonded together. The polymer includes any of a variety of natural, synthetic and semi-synthesized polymers.

A natural polymer refers to any number of polymer species derived from nature. Such polymer includes, but is not limited to, polysaccharide, cellulose, chitin, and alginate.

A synthesized polymer refers to any number of synthesized polymer species that are not naturally present. The synthesized polymer includes, but is not limited to, synthesized homopolymer and synthesized copolymer.

A synthesized homopolymer includes, but is not limited to, polyethylene glycol, polylactide, polyglycolide, polyacrylic, polymethacrylate, poly-caprolactone, polyorthoester, polyanhydride, polylysine, and polyethyleneimine.

A synthesized copolymer refers to any number of synthesized polymer species constructed from two or more synthesized homopolymer subunits. The synthesized copolymer includes, but is not limited to, poly (lactide-co-glycolide), poly (lactide)-poly (ethylene glycol), poly (lactide-co-glycolide)-poly (ethylene glycol), and poly (caprolactone)-poly (ethylene glycol).

A semi-synthesized polymer refers to any number of polymers derived by chemical or enzymatic treatment of natural polymers. Such polymer includes, but is not limited to, carboxymethyl cellulose, acetylated carboxymethyl cellulose, cyclodextrin, chitosan and gelatin.

A polymer conjugate refers to a compound prepared by covalently or non-covalently conjugating one or more kinds of molecular species to a polymer. The polymer conjugate includes, but is not limited to, a polymeric-therapeutic substance conjugate.

A polymeric-therapeutic substance conjugate refers to a polymer conjugate in which one or more of the conjugated molecular species is a therapeutic substance. The polymeric-therapeutic substance conjugate includes, but is not limited to, a polymer-drug conjugate.

A polymer-drug conjugate refers to any number of polymers conjugated to any number of drug species. The polymer-drug conjugate includes, but is not limited to, acetylmethylcellulose-polyethylene glycol-docetaxel.

### Method for Using a Microfluidic Hybrid Chip Cartridge

In one aspect, a method for generating a microparticle is provided. In one Example, the method includes flowing a first solution and a second solution through a microfluidic hybrid chip cartridge according to any disclosed Example and forming a nanoparticle solution in a first mixer.

The method for preparing a nanoparticle mainly includes the following steps:

1) respectively preparing a sample 1 and a sample 2, wherein the sample 1 is a nucleic acid substance, and the sample 2 is a polymer or lipid solution;

2) respectively injecting a sample 1 and a sample 2 from different liquid inlets; 3) collecting the prepared nanoparticle from a liquid outlet.

Methods for generating a microparticle with a microfluidic hybrid chip cartridge are generally known in the art, and these methods can be used with the disclosed microfluidic hybrid chip cartridges, which essentially provide an improved and simplified way of carrying out the known methods. Exemplary methods disclosed in the patent documents are incorporated herein by reference. The following embodiments describe specific methods for forming a siRNA lipid nanoparticle using an exemplary microfluidic hybrid chip cartridge.

In one Example, the first solution includes nucleic acid in a first solvent.

In one Example, the second solution includes a lipid particle-forming material in a second solvent.

In one Example, a plurality of microfluidic hybrid chip cartridges are included for use in parallel.

In one Example, a microfluidic hybrid chip cartridge includes a plurality of mixers, and the method includes flowing a first solution and a second solution through the plurality of mixers to form a nanoparticle solution.

In still other embodiments, a third solution may be introduced to dilute the mixed solution. Methods of using microfluidic hybrid chip cartridges also include methods performed in a sterile environment, such as a formation of certain nanoparticles (e.g., nanopharmaceuticals) that must be done in a sterile environment. In one Example, the method further includes the step of sterilizing a fluid path prior to the step of flowing the first solution and the second solution through the microfluidic hybrid chip cartridge. In one Example, sterilizing the fluid path includes sterilizing the microfluidic cartridge with radiation. In one Example, sterilizing the fluid path includes sterilizing portions of the microfluidic cartridge before assembling the microfluidic cartridge. In one Example, the sterile fluid path includes a fluid path from a first inlet connector and a second inlet connector, through a microfluidic structure, and to an outlet opening. In one Example, the sterile fluid path further includes a first syringe containing a first solution coupled to a first inlet. In one Example, the sterile fluid path further includes a second syringe containing a second solution coupled to a second inlet. In one Example, the sterile fluid path further includes a sterile container coupled to an outlet opening of the microfluidic hybrid chip cartridge via an outlet opening connector, and wherein the method further includes the step of delivering the nanoparticle solution from the mixer to the sterile container via an outlet microchannel and the outlet opening. In one Example, the method further includes a step of removing a sterile packaging from the microfluidic hybrid chip cartridge prior to a step of flowing the first solution and the second solution through the microfluidic hybrid chip cartridge.

### BRIEF DESCRIPTION OF THE DRAWINGS

FIG. 1 is a schematic diagram showing the structure of a microfluidic hybrid chip cartridge containing microfluidic chips in one Example;

FIG. 2 is a schematic diagram showing the structure of a microfluidic chip of a mixer in one Example;

FIG. 3 is a schematic perspective view of a mixing unit of microparticle channels in one Example

FIG. 4 is an enlarged structural view of a mixing unit in one Example;

FIG. 5 is a schematic view showing the structure of the mixer provided in Example 1;

FIG. 6 is a cross-sectional view A-A of FIG. 5, and FIG. 3 is a schematic view showing the flow direction of the sample in the mixer;

FIG. 7 is a schematic view showing the flow direction of the sample in the mixer provided in Example 1;

FIG. 8 is a schematic view showing the structure of the microfluidic hybrid chip provided in Example 2;

FIG. 9 is a schematic view showing the structure of the microfluidic hybrid chip cartridge provided in Example 2;

FIG. 10 is a schematic view showing the back structure of the microfluidic hybrid chip cartridge provided in Example 2;

FIG. 11 is a schematic side view showing a microfluidic hybrid chip cartridge provided in Example 2;

FIG. 12 is a schematic view showing a use state of the microfluidic hybrid chip cartridge provided in Example 2;

FIG. 13 is a schematic diagram of a microfluidic hybrid chip cartridge for generating a microparticle in parallel with high-throughput composed of a plurality of microfluidic hybrid chip cartridges provided in Example 3 in parallel;

FIG. 14 is a graph showing the continuous stability test results of a lipid nanoparticle prepared by the microfluidic hybrid chip provided in Example 5 of the present invention and a fishbone chip commercially available from a manufacturer PNI;

FIG. 15 is a comparison of fluorescence intensity of an in vitro transfection of eGFP-LPP prepared by the microfluidic hybrid chip provided in Example 6 of the present invention with that prepared by a fishbone chip commercially available from a manufacturer PNI;

FIG. 16 is a comparison of the expression levels of GFP proteins of an in vitro transfection of eGFP-LPP prepared by the microfluidic hybrid chip provided in Example 6 of the present invention with that prepared by a fishbone chip commercially available from a manufacturer PNI; and

FIG. 17 is a schematic diagram of various other curvilinear configurations of mixing cell channels in a particular embodiment.

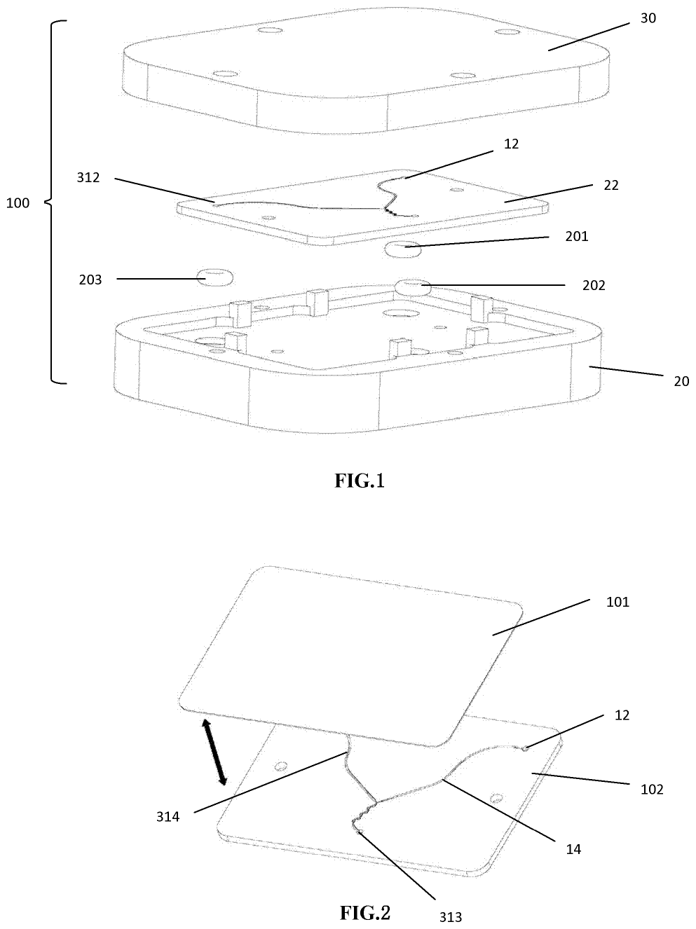

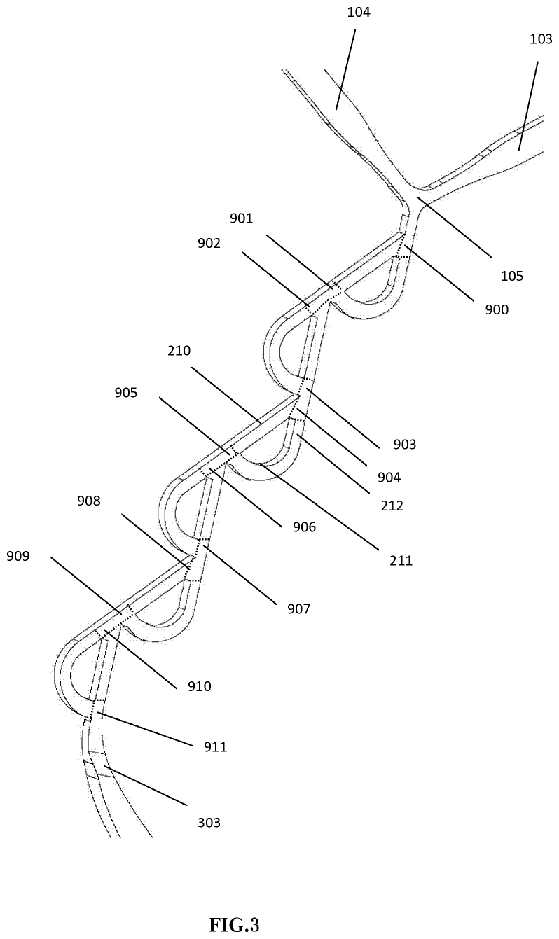

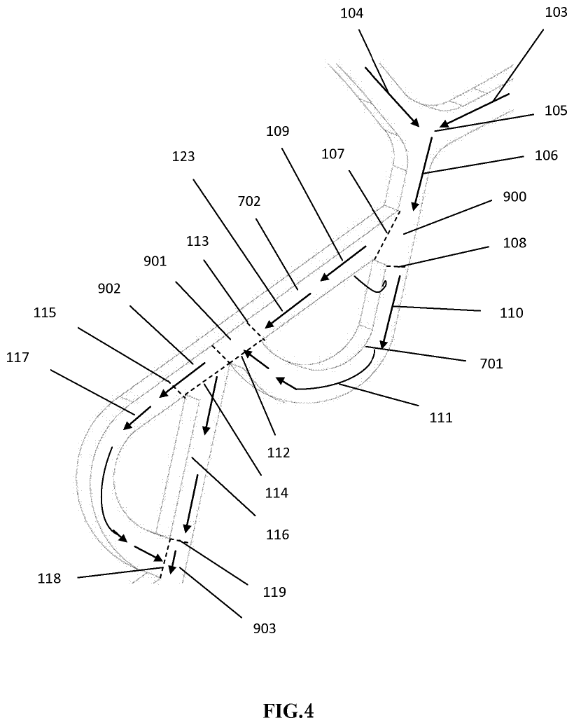

### DETAILED DESCRIPTION OF THE INVENTION

Preferred embodiments of the present invention will be described in further detail below with reference to the accompanying drawings, and it should be noted that the following embodiments are intended to facilitate understanding of the present invention without any limitation thereto. The raw materials and equipment used in the particular embodiment of the present invention are all known products and are obtained by purchasing commercially available products.

In the description of the present invention, it is to be understood that the terms “central”, “longitudinal”, “lateral”, “upper”, “lower”, “front”, “rear”, “left”, “right”, “vertical”, “horizontal”, “top”, “bottom”, “inner”, “outer” and the like are used in the orientations and positional relationships indicated in the drawings, which are based on the orientations and positional relationships indicated in the drawings, and are used for convenience in describing the present invention and for simplicity in description, but do not indicate or imply that the device or element so referred to must have a particular orientation, be constructed in a particular orientation, and be operated, and thus should not be construed as limiting the present invention. Furthermore, the terms “first”, “second”, and the like are used for descriptive purposes only and are not to be construed as indicating or implying relative importance or implicitly indicating the number of technical features indicated. Thus, features defining “first”, “second”, etc. may explicitly or implicitly include one or more such features. In the description of the present invention, unless otherwise specified, the meaning of “a plurality of” means two or more.

In describing the present invention, it is to be understood that the terms “mounted”, “coupled”, and “connected” are to be interpreted broadly, for example, either fixedly or removable, or integrally, unless expressly specified and limited otherwise, can be mechanically or electrically, directly or indirectly through an intermediary, and may be internally between two elements. The specific meaning of the above terms in the present invention can be understood by a person skilled in the art under specific circumstances.

### Example 1 Mixer Provided by the Present Invention

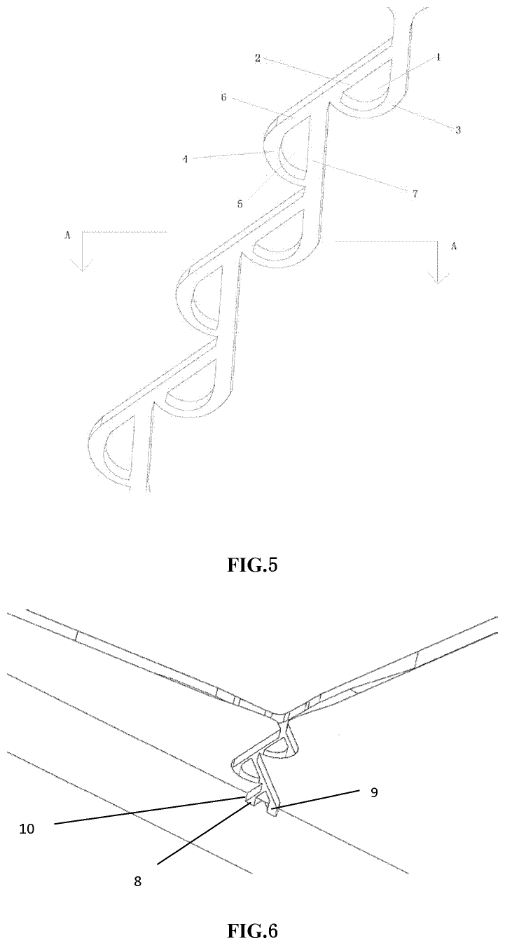

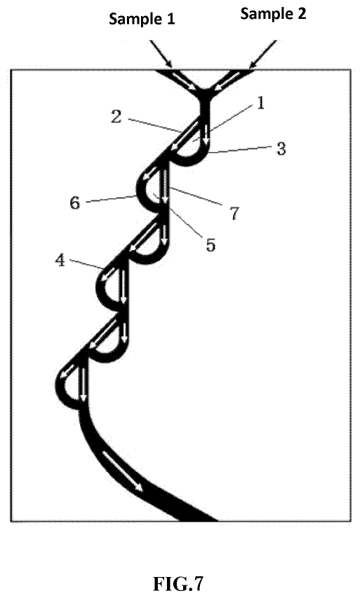

A schematic diagram of the mixer provided by the Example is shown in FIGS. 5, 6 and 7, wherein FIG. 5 is a schematic diagram showing the structure of the mixer, FIG. 6 is a sectional view A-A of FIG. 5, and FIG. 7 is a schematic diagram showing the flow direction of a sample in the mixer.

As shown in FIG. 5, the mixer provided by the example includes a mixing unit 1 provided with a first channel 2 being curvilinear and a second channel 3 being rectilinear, which are connected head to end, i.e. connected head to head, and end to end, respectively.

Preferably, the second channel 3 is semi-circular arc-shaped and has a rectilinear initial segment 4.

Preferably, a length of the segment 4 is smaller than or equal to ⅓ of a length of the second channel.

Preferably, the mixer includes two or more mixing units, and each of the mixing units is connected end to end; two adjacent mixing units are a mixing unit A 1 and a mixing unit B 5, the second passage 3 of the mixing unit A is positioned on a right side of the first passage 2, and the second passage 6 of the mixing unit B 5 is positioned on a left side of the first passage 7.

Preferably, all channel widths 8 are consistent.

As shown in FIG. 6, preferably, a channel section 9 of the mixer provided by the present invention is rectangular, all the channel section lengths 10 are consistent, and all the channel widths 8 are uniform. The channel section 9 of the mixer can be made in various shapes as desired, such as circular, semi-circular, square, rectangular, triangular, trapezoidal, etc., and for convenience, the channel section of this example is preferably rectangular or square.

Preferably, the first channel 2 of each of the mixing units communicates in line with the segment 4 of the second channel 6 of the next mixing unit.

Preferably, the mixer includes six mixing units 1.

Preferably, the mixing effect can also be further improved by adding more mixing units in series.

Preferably, a plurality of mixers provided in this example may also be used in series to improve the mixing effect, depending on a need to prepare the product.

The flow direction of the sample fluid in the mixer is shown in FIG. 7, and the sample flows up and down and is thoroughly mixed in the mixer.

### Example 2 Microfluidic Hybrid Chip Cartridge Provided by the Present Invention

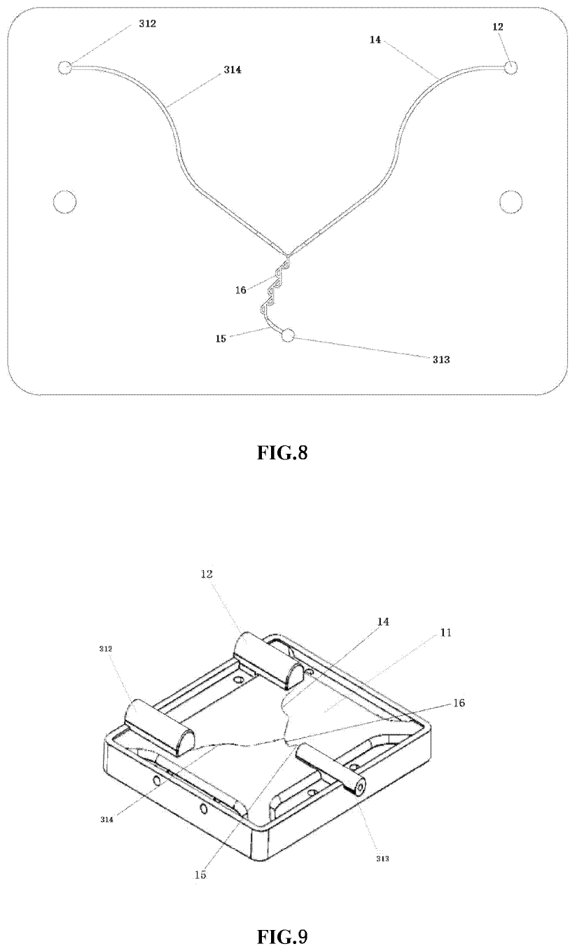

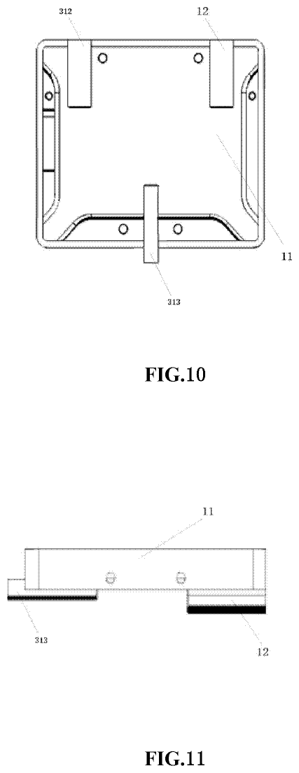

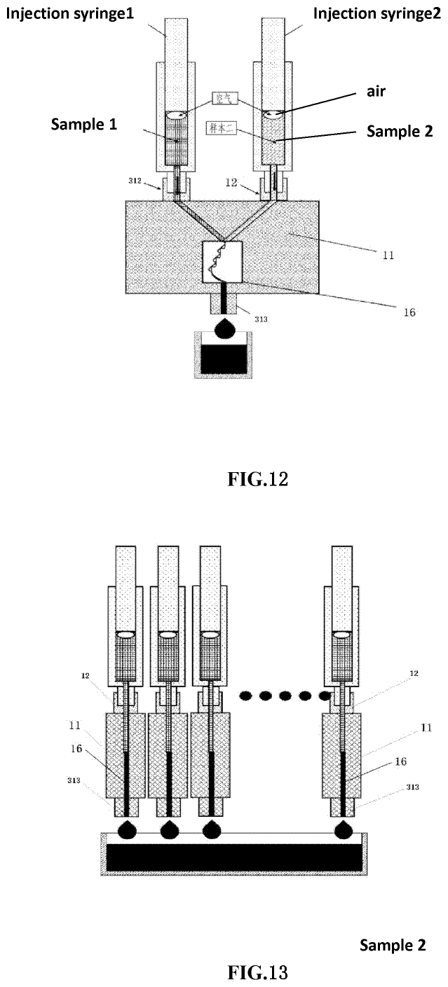

The microfluidic hybrid chip cartridge provided by the Example is shown in FIGS. 8-12, wherein FIG. 8 is a structural schematic diagram of the microfluidic hybrid chi, FIG. 9 is a structural schematic diagram of the microfluidic hybrid chip cartridge with the packaging cartridge, FIG. 10 is a back structural schematic diagram of the microfluidic hybrid chip cartridge with the packaging cartridge, FIG. 11 is a side structural schematic diagram of the microfluidic hybrid chip cartridge with the packaging cartridge, and FIG. 12 is a schematic view showing a state of use of the microfluidic hybrid chip cartridge.

The microfluidic hybrid chip cartridge provided by the example includes the microfluidic mixer provided by the Example 1.

As shown in FIGS. 8-11, the example provides a microfluidic hybrid chip cartridge which includes a chip 11 provided thereon with liquid inlets 12 and 312, a liquid outlet 313, liquid inlet conduits 14 and 314, a liquid outlet conduit 15 and a mixer 16, and the liquid inlets 12 and 312 and the liquid outlet 313 are perpendicular to a side wall of the chip; the liquid inlet conduit 14 is connected with the liquid inlet 12 and the mixer 16, the liquid inlet conduit 314 is connected with the liquid inlet 312 and the mixer 16, the liquid outlet conduit 15 is connected with the liquid outlet 313 and the mixer 16, and the packaging cartridge 17 is arranged outside the chip. The liquid inlets 12 and 312 and the liquid outlet 13 are respectively located at either side of the chip 11.

Preferably, the inlets 12 and 312 and the inlet conduits 14 and 314 are in the same plane, and the liquid outlet 313 and the outlet conduit 15 in the same plane.

Preferably, the inlets 12 and 312, the inlet conduits 14 and 314, the liquid outlet 313, the outlet conduit 15 and the chip 11 are all substantially in the same plane. The sample is applied by injection only from a side of the chip 11.

As shown in the FIG. 12, the microfluidic hybrid chip cartridge provided by the present invention has the advantages that liquid inlets 12 and 312 and a liquid outlet 13 are arranged perpendicular to a side wall of a chip 11. When it is used, a syringe is disposed vertically downward for injection, the chip 11 and the syringe are in the same plane, and the syringe is placed vertically downward after it extracts a liquid sample, such that bubbles naturally float to the top inside the syringe, then the syringe is inserted vertically downward into the liquid inlets 12 and 312 of the chip 11, and the liquid in the syringe is completely injected into the liquid inlets 12 and 312. The bubbles float up to the top of the syringe, thus it is not needed to worry about injection of the bubbles, and waste of expensive sample liquid due to manual removal of bubbles at the head of a syringe was avoided.

### Example 3 Microfluidic Hybrid Chip Cartridge Provided by the Present Invention for Generating a Microparticle in Parallel with High-Throughput

As shown in the FIG. 13, the present invention provides a microfluidic mixing cartridge for generating nanoparticles in parallel with high-throughput, which is composed of a plurality of microfluidic hybrid chip cartridges provided in Example 2 in parallel. Due to the fact that the liquid inlets 12 and 312, the liquid outlet 313 and the chip 11 are in the same plane, injection only needs to be carried out from the side surface of the chip 11 during sample application, a plurality of microfluidic hybrid chips can be stacked, thus the microfluidic hybrid chips can be used in parallel with high-throughput and can be used for generating microparticles in parallel with high-throughput.

### Example 4 Performance Comparison of Different Chips

The microfluidic hybrid chip provided by the Example 2 and the commercially available fishbone chip manufactured by PNI are respectively used for preparing a lipid nanoparticle, and the influence of different mixing flow rates on the particle size of the lipid nanoparticle is investigated. To be specific, an appropriate amount of lipid solution (ionizable lipid MC3, DSPC, cholesterol, mPEG2000-DMG prepared into 10 mg/ml lipid solution according to a molar ratio of 50:10:38.5:1.5) is mixed with eGFP-mRNA (dissolved in 1 mM of citric acid-sodium citrate buffer at pH 6.4, mRNA sequence of GFP:

| | AUGGUGAGCA AGGGCGAGGA GCUGUUCACC GGGGUGGUGC |
|---|---|
| | CCAUCCUGGU CGAGCUGGAC GGCGACGUAA ACGGCCACAA |
| | GUUCAGCGUG UCCGGCGAGG |
| 101 | GCGAGGGCGA UGCCACCUAC GGCAAGCUGA CCCUGAAGUU |
| | CAUCUGCACC ACCGGCAAGC UGCCCGUGCC CUGGCCCACC |
| | CUCGUGACCA CCCUGACCUA |
| 201 | CGGCGUGCAG UGCUUCAGCC GCUACCCCGA CCACAUGAAG |
| | CAGCACGACU UCUUCAAGUC CGCCAUGCCC GAAGGCUACG |
| | UCCAGGAGCG CACCAUCUUC |
| 301 | UUCAAGGACG ACGGCAACUA CAAGACCCGC GCCGAGGUGA |
| | AGUUCGAGGG CGACACCCUG GUGAACCGCA UCGAGCUGAA |
| | GGGCAUCGAC UUCAAGGAGG |
| 401 | ACGGCAACAU CCUGGGGCAC AAGCUGGAGU ACAACUACAA |
| | CAGCCACAAC GUCUAUAUCA UGGCCGACAA GCAGAAGAAC |
| | GGCAUCAAGG UGAACUUCAA |
| 501 | GAUCCGCCAC AACAUCGAGG ACGGCAGCGU GCAGCUCGCC |
| | GACCACUACC AGCAGAACAC CCCCAUCGGC GACGGCCCCG |
| | UGCUGCUGCC CGACAACCAC |
| 601 | UACCUGAGCA CCCAGUCCGC CCUGAGCAAA GACCCCAACG |
| | AGAAGCGCGA UCACAUGGUC CUGCUGGAGU UCGUGACCGC |
| | CGCCGGGAUC ACUCUCGGCA |
| 701 | UGGACGAGCU GUACAAGUAA), |

mixed at different flow rates of 1, 6, 12, and 20 ml/min, fixed mixing ratio of 3 (mRNA solution):1 (lipid solution), constant temperature of 37° C. to obtain a lipid nanoparticle, and a particle size is measured by a dynamic light scattering particle size analyzer and repeated three times, with the results shown in Table 1.

TABLE 1
Comparison of the particle sizes of lipid
nanoparticles made from different chips

| Sequence | Mixing flow rate | PNI fishbone | Microfluidic hybrid chip |
|---|---|---|---|
| number | (ml/min) | chip (nm) | (nm) of Example 1. |
| 1 | 1 | 164.7 ± 1.1 | 156.9 ± 7.9 |
| 2 | 6 | 88.7 ± 8.1 | 90.6 ± 5.4 |
| 3 | 12 | 87.1 ± 4.1 | 87.2 ± 4.9 |
| 4 | 20 | 76.7 ± 1.8 | 83.4 ± 8.5 |

As can be seen from table 1, a particle size of the lipid nanoparticle prepared by the chip provided in Example 1 of the present invention is not much different from that of the lipid nanoparticle prepared by a fishbone chip commercially available from a manufacturer PNI within each flow rate range (1, 6, 12, 20 ml/min), but the particle size of the lipid nanoparticle prepared by the chip provided in Example 1 is more stable, and the difference in the particle size is smaller at different flow rates. Therefore, the nanoparticles prepared by the microfluidic hybrid chip provided by the present invention is more uniform and stable, the flow resistance are smaller, the mixing efficiency is higher, production in parallel with high-throughput can also be carried out, and the effect achieved is obviously superior to that achieved by the existing microfluidic chip.

### Example 5 Continuous Stability Testing of Chips

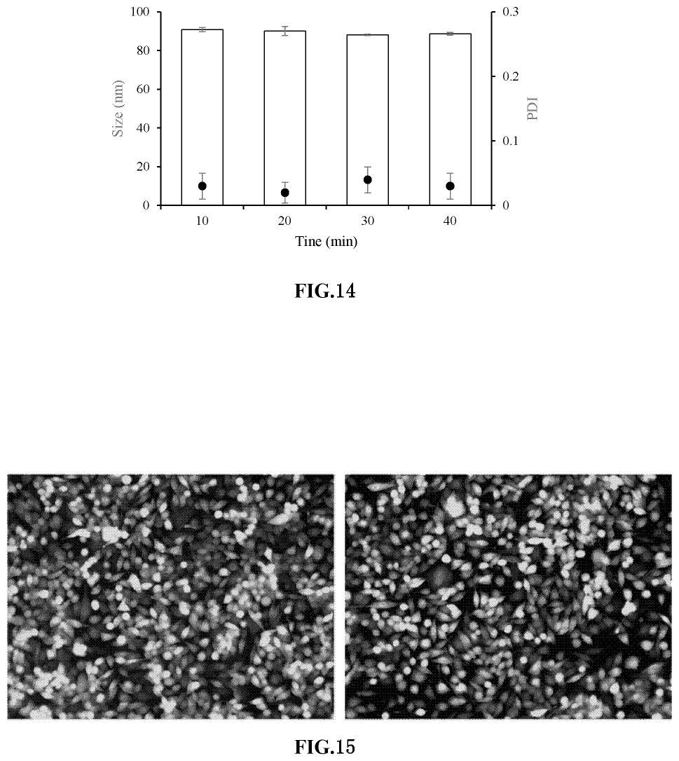

The microfluidic hybrid chip provided by the Example 2 is used for preparing lipid nanoparticles to investigate stability of the chip under continuous mixing preparation. To be specific, an appropriate amount of the lipid solution was mixed with eGFP-mRNA, respectively, at a fixed mixing ratio of 20 ml/min, at a fixed flow rate of mixing 3 (mRNA solution):1 (lipid solution), at a constant temperature of 37° C., mixed for 40 min, points were taken every 10 min to obtain lipid nanoparticles, and a particle size was tested with a dynamic light scattering particle sizer, repeated three times, and the results are as shown in FIG. 14 (composition of lipid solution and eGFP-mRNA refers to Example 4).

The test results in the FIG. 14 show that the chip structure provided by the present invention is good in continuous stability, the particle size obtained after the chip is continuously operated for 40 minutes is equivalent to an initial value, and the polydispersity index PDI is smaller than 0.05.

### Example 6 Fluorescence Imaging and GFP Expression Quantification of eGFP-LPP Prepared by Different Chips

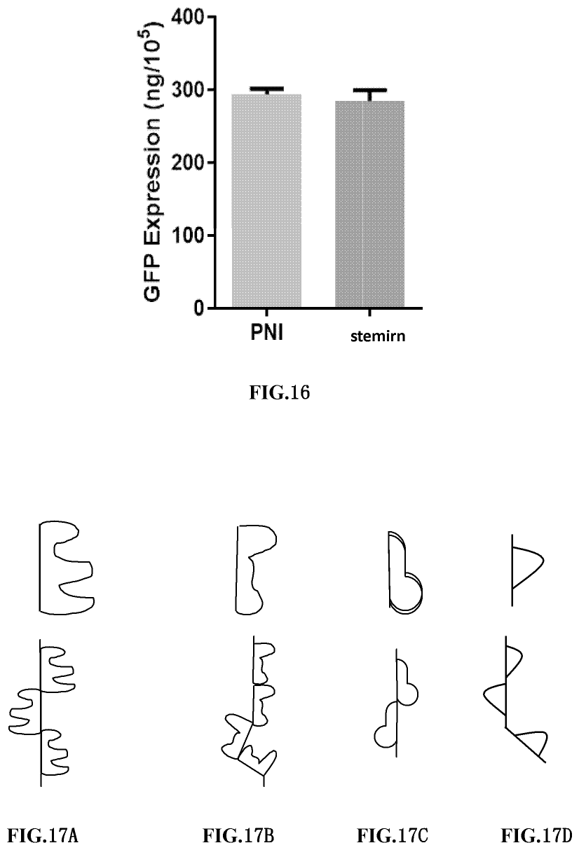

The microfluidic mixed chip provided in Example 2 and a fishbone chip commercially available from a manufacturer PNI are respectively used for preparing a lipid nanoparticle, a prepared eGFP-LPP is transfected in vitro, fluorescence imaging and GFP expression quantitative results of the eGFP-LPP prepared by different chips are investigated. To be specific, the prepared lipid nanoparticles containing 100 ng of eGFP-mRNA prepared by different chips (containing fluorescent mRNA) were incubated with 2×104 DC2.4 cells for 24 hours, then observed GFP expression of same using a fluorescence microscope, as shown in FIG. 15, and finally GFP expression is quantified using a GFP quantification kit, as shown in FIG. 16 (the composition of the lipid solution and eGFP-mRNA refers to example 4).

As can be seen in FIG. 15, the test results show that the fluorescence intensity of the in vitro transfection of eGFP-LPP prepared by the chip provided in Example 1 is comparable to that of eGFP-LPP prepared by a fishbone chip commercially available from a manufacturer PNI.

As shown by the test results of FIG. 16, the expression levels of GFP proteins of an in vitro transfection of eGFP-LPP prepared by the microfluidic hybrid chip provided in Example 1 is comparable to that of the GFP proteins of an in vitro transfection of eGFP-LPP from a fishbone chip commercially available from a manufacturer PNI without much significant difference.

### Example 7 Comparison of Mixing Effects of Different Number of Mixing Units

The microfluidic hybrid chip provided in Example 2 is adopted, wherein the number of the mixing units is 2, 4, 6, 8, and 10, and the lipid nanoparticles are prepared respectively. To be specific, an appropriate amount of the lipid solution is mixed with the eGFP-mRNA, respectively ((composition of the lipid solution and eGFP-mRNA refers to Example 4). Same is continuously mixed at a fixed mixing flow rate of 20 ml/min, a fixed mixing ratio of 3 (mRNA solution):1 (lipid solution), at a fixed temperature of 37° C. for 40 min, points are taken every 10 min to obtain lipid nanoparticles, a particle size was tested by using a dynamic light scattering particle sizer, a dispersion index PDI and encapsulation efficiency were calculated, repeated three times, and the results are as shown in Table 2.

TABLE 2
Comparison of polymer/mRNA nanoparticle generation
using different numbers of units

| Mixing unit | | PDI (Dispersion | Encapsulation |
|---|---|---|---|
| number | Particle size | Index) | efficiency (%) |
| 2 | 72.4 ± 2.5 | 0.145 | 90.3% |
| 4 | 79.2 ± 3.7 | 0.112 | 92.7% |
| 6 | 83.5 ± 8.5 | 0.040 | 99.6% |
| 8 | 84.1 ± 6.3 | 0.042 | 99.4% |
| 10 | 84.9 ± 5.0 | 0.043 | 99.1% |

As can be seen from Table 2, the mixing effect when a mixing pipe using 6 mixing units is used for preparing the nanoparticles can completely satisfy the mixing effect requirement required for preparing nanoparticles.

Although the present invention is disclosed above, the present invention is not limited thereto. For example, the present invention can be extended according to the application range of the microfluidic field. Those skilled in the art can make various changes and modifications without departing from the spirit and scope of the present invention, and therefore, the scope of the present invention should be determined by the scope of the claims.

The invention shown and described herein may be implemented in the absence of any element or elements, limitation or limitations specifically disclosed herein. The terms and expressions which have been employed are used as terms of description and not of limitation, and there is no intention in the use of such terms and expressions of excluding any equivalents of the features shown and described or portions thereof, and it is recognized that various modifications are possible within the scope of the present invention. It is therefore to be understood that, although the present invention has been particularly disclosed by various embodiments and optional features, modifications and variations of the concepts herein described may be resorted to by a person skilled in the art, and that such modifications and variations are considered to fall within the scope of the present invention as defined by the appended claims.

The contents of the articles, patents, patent applications, and all other documents and electronically available information described or described herein are hereby incorporated by reference in their entirety to the same extent as if each individual publication was specifically and individually indicated to be incorporated by reference. Applicants hereby incorporate into this application any and all materials and information retained from any such article, patent, patent application or other document.

1. A mixer for generating particles, comprising a first mixing unit, wherein the first mixing unit comprises a first channel and a second channel, and the first channel comprises a rectilinear channel, and the second channel comprises a curvilinear channel.

2. The mixer according to claim 1, wherein the first channel comprises a first inlet and a first outlet, the second channel comprises a second inlet and a second outlet, the first inlet being in fluid communication with the second inlet, and the first outlet being in fluid communication with the second outlet.

3. The mixer according to claim 1, wherein the mixing unit further comprises a first converging region, the first converging region being in communication with the first inlet of the first channel and the second inlet of the second channel to divert a fluid.

4. The mixer according to claim 3, wherein the mixing unit further comprises a second converging region, the second converging region being in communication with the first outlet of the first channel and the second outlet of the second channel to converge fluids.

5. The mixer according to claim 1, wherein the curvilinear channel of the second channel comprises a semi-circular or arc-shaped channel.

6. The mixer according to claim 1, wherein the second channel further comprises a rectilinear initial channel, the initial channel being disposed in the upstream of the curvilinear channel.

7. The mixer according to claim 6, wherein a length of the initial segment channel is less than or equal to ⅓ of a length of the second channel.

8. The mixer according to claim 6, wherein an included angle between the initial channel and the first channel is an acute angle of less than 90 degrees.

9. The mixer according to claim 3, wherein the mixer further comprises a premixing channel, the premixing channel being in communication with the first converging region in configure to mix two different fluids.

10. The mixer according to claim 9, wherein the mixer further comprises a first transporting channel for transporting a first fluid and a second transporting channel for transporting a second fluid, the first and second transporting channels being in fluid communication with the premixing channel.

11. The mixer according to claim 2, wherein the mixer further comprises a second mixing unit comprising a third channel and a fourth channel, wherein the third channel comprises a curvilinear channel and the fourth channel comprises a rectilinear channel.

12. The mixer according to claim 11, wherein the third channel comprises a third inlet and the fourth channel comprises a fourth inlet.

13. The mixer according to claim 12, wherein the inlet of the fourth channel is adjacent to the outlet of the second channel of the first mixing unit, or the inlet of the fourth channel and the outlet of the second channel of the first mixing unit are on the same side of the channel, or the third inlet of the third channel is disposed opposite the outlet of the first channel of the first mixing unit.

14. The mixer according to claim 12, wherein the fourth channel is disposed at an obtuse angle of greater than 90 degrees with the first channel.

15. The mixer according to claim 12, wherein the third channel further comprises a rectilinear initial channel in an upstream side of the curvilinear channel, the initial channel being a partial extension of the first rectilinear channel.

16. The mixer according to claim 12, wherein the mixer comprises a third converging region, a part of a fluid in the third converging region enters into the third channel and a part of the fluid in the third converging region enters into the second channel.

17. The mixer according to claim 1, wherein the mixer further comprises a second mixing unit comprising a third channel and a fourth channel, wherein the third channel comprises a curvilinear channel and the fourth channel comprises a rectilinear channel, the third channel and the first channel are on the same side of the mixing unit, and the fourth channel and the second channel are on the other same side of the mixing unit.

18. The mixer according to claim 1, wherein the mixer further comprises a second mixing unit, wherein the first mixing unit is located upstream side of the second mixing unit, and the second mixing unit comprises a third channel and a fourth channel, wherein the third channel comprises a curvilinear channel and the fourth channel comprises a rectilinear channel; and the fourth channel is taken as a reference, the curvilinear channel of the first mixing unit and the curvilinear channel of the second mixing unit are respectively positioned on either side of the fourth channel.

19. A mixer according to any one of claims 1 to 18, wherein all channels are of the same widths or the same depths.

20. A mixer according to any one of claims 1 to 19, wherein a cross-sections of the channels are rectangular.

21. A mixer for generating a nanoparticle, comprising N mixing units, wherein each of the mixing units comprises a first channel comprising a rectilinear channel, and a second channel comprising a curvilinear channel, the first channel having a first inlet and a first outlet, the second channel having a second inlet and a second outlet, the first inlet and the second inlet being in fluid communication, wherein N is a natural integer from 1 to 6.

22. A mixer for generating a microparticle, comprising a first mixing unit, wherein the first mixing unit comprises a first channel for receiving a first fluid and a second channel for receiving a second fluid, wherein a flow path of the first fluid in the first channel is smaller than a flow path of the second fluid in the second channel.

23. A mixer for generating a microparticle, comprising a first mixing unit, wherein the first mixing unit comprises a first channel for receiving a first fluid and a second channel for receiving a second fluid, wherein a length of the first channel is less than a length of the second channel.

24. A mixer for a nanoparticle, comprising N+1 mixing units, the N^{th} mixing unit comprising an a^{th} rectilinear channel and an a+1^{th} curvilinear channel, the a^{th} rectilinear channel comprising an a^{th} fluid inlet and an a^{th} fluid outlet, the a+1^{th} curvilinear channel comprising an a+1^{th} flow inlet and an a+1^{th} fluid outlet, wherein N is a natural integer equal to or greater than 1, and a is a natural number greater than or equal to 1.

25. The mixer according to claim 24, wherein the fluid inlet of the a^{th} rectilinear channel and the fluid inlet of the a+1^{th} curvilinear channel comprises an a^{th} converging region to divert fluids at the converging region; or, the fluid outlet of the a^{th} rectilinear channel and the fluid outlet of the a+1^{th} curvilinear channel being in communication with an a+1^{th} converging region to mix or converge or merge a fluid from the two channels.

26. The mixer according to claim 24, wherein the N+1^{th} mixing unit comprises an a+2^{th} rectilinear channel and an a+3^{th} curvilinear channel, the a+2^{th} rectilinear channel comprises an a+2^{th} fluid inlet and an a+2^{th} fluid outlet, and the a+3^{th} curvilinear channel comprises an a+3^{th} fluid inlet and an a+3^{th} fluid outlet.

27. The mixer according to claim 26, wherein the a^{th} fluid outlet is disposed opposite to the a+3^{th} fluid inlet.

28. The mixer according to claim 26, wherein an a+1^{th} fluid outlet is disposed adjacent to an a+2^{th} fluid inlet or on the same side of a channel.

29. The mixer according to claim 26, wherein an upstream side of the curvilinear channel comprises a rectilinear channel comprising the fluid inlet of the curvilinear channel.

30. The mixer of any one of claims 21-29, wherein the mixer comprises a pre-premixing channel for flowing fluid into the first and second channels, the pre-premixed fluid channel being in the upstream sides of the first and second channels, or in the upstream of the rectilinear channel and the a+1^{th} curvilinear channel, where a=1.

31. The mixer according to claim 30, wherein the pre-premixing channel comprises a mixed fluid of the first and second fluids.

32. The mixer according to claim 31, wherein the first fluid comprises a nucleic acid and the second fluid comprises a polymer.

33. The mixer according to claim 31, wherein the first fluid comprises a nucleic acid and the second fluid comprises a lipid component.

34. The mixer according to claim 31, wherein the first fluid comprises a microparticle formed from a nucleic acid and a polymer, and the second fluid comprises a lipid component.

35. A method for preparing a microparticle, the method comprising:
providing the mixer according to any one of claims 1 to 34, passing a fluid from a premixing channel into a first mixing unit, wherein one part of the fluid enters a first channel of the first mixing unit and another part of the fluid enters a second channel of the first mixing unit.

36. The method according to claim 35, wherein a premixed fluid flows in through a first inlet of a first channel in communication with a first converging region and then through a second inlet of a second channel.

37. The method according to claim 30, wherein a fluid passing through the first and second channels of the first mixing unit converges at a second converging region.

38. The method according to claim 37, wherein a fluid from the first converging region enters the third and fourth channels, respectively, through inlets of the third and fourth channels of the second mixing unit in communication with the third converging region.

39. The method according to claim 36, wherein the fluid in the first mixing unit is flowed by externally applying pressure to the channel externally applying pressure to the channel.

40. The method according to claim 37, wherein the first and second fluids are premixed in a premixing channel.

41. A method for preparing a microparticle, the method comprising providing a mixed fluid, passing one part of the fluid through a first channel, and passing a rest part of the fluid through a second channel, wherein a path through which the fluid passes in the first channel is less than a path through which the fluid passes in the second channel.

42. The method according to claim 41, wherein the fluid comprises one or more of a nucleic acid, a polymer, or a lipid component substance.

43. The method according to claim 41, wherein the first channel comprises a rectilinear channel and the second channel comprises a curvilinear channel.

44. The method according to claim 41, wherein a premixing channel is provided in the upstream sides of the first and second channels, a first fluid and a second fluid being mixed into a mixed fluid in the premixing channel.


SEQUENCE LISTING (1 sequence)

SEQ ID NO: 1 - RNA, 720 nt, Artificial Sequence
  eGFP-mRNA
auggugagcaagggcgaggagcuguucaccgggguggugcccauccuggucgagcuggacggcgacguaaacggccacaaguucagcguguccggcgagggcgagggcgaugccaccuacggcaagcugacccugaaguucaucugcaccaccggcaagcugcccgugcccuggcccacccucgugaccacccugaccuacggcgugcagugcuucagccgcuaccccgaccacaugaagcagcacgacuucuucaaguccgccaugcccgaaggcuacguccaggagcgcaccaucuucuucaaggacgacggcaacuacaagacccgcgccgaggugaaguucgagggcgacacccuggugaaccgcaucgagcugaagggcaucgacuucaaggaggacggcaacauccuggggcacaagcuggaguacaacuacaacagccacaacgucuauaucauggccgacaagcagaagaacggcaucaaggugaacuucaagauccgccacaacaucgaggacggcagcgugcagcucgccgaccacuaccagcagaacacccccaucggcgacggccccgugcugcugcccgacaaccacuaccugagcacccaguccgcccugagcaaagaccccaacgagaagcgcgaucacaugguccugcuggaguucgugaccgccgccgggaucacucucggcauggacgagcuguacaaguaa